(19) United States
(12) Patent Application Publication
(10) Pub. No.: US 2015/0348457 A1
(43) Pub. Date: Dec. 3, 2015

(54) DISPLAY DEVICE AND ELECTRONIC APPARATUS

(71) Applicant: SEIKO EPSON CORPORATION, Shinjuku-ku, Tokyo (JP)

(72) Inventor: Akihiko ITO, Tatsuno-machi (JP)

(21) Appl. No.: 14/758,181

(22) PCT Filed: Dec. 18, 2013
(86) PCT No.: PCT/JP2013/007436

§ 371 Date: Jun. 26, 2015

(30) Foreign Application Priority Data
Dec. 28, 2012 (JP) 2012-287711

(51) Int. Cl. G09G 3/20; G09G 3/36

(52) U.S. Cl. CPC G09G 3/2007; G09G 3/3614; G09G 3/3648; G09G 2310/0205; G09G 2310/027

(57) ABSTRACT

A display device including: a scanning line driving circuit which selects scanning lines of a first set in the even row and one of two scanning lines in the odd row in a first unit period, and selects scanning lines of a second set in the even row and the other of two scanning lines in the odd row in a second unit period; and a signal line driving circuit which supplies a first grayscale potential to four pixels corresponding to an intersection of the scanning lines of the first set and the two signal lines in the first unit period, and supplies a second grayscale potential to four pixels corresponding to an intersection of the scanning lines of the second set and the two signal lines in the second unit period.

### TECHNICAL FIELD

The present invention relates to a display device and an electronic apparatus.

### BACKGROUND ART

In recent years, high resolution of a display device such as a projector or a liquid crystal television is advancing. In order to display an image having high resolution in such a display device, it is necessary to increase an operating speed of a circuit which generates image data or a circuit which controls a display operation, and as a result, this leads to high cost of the display device due to a large scale or complicated circuit.

PTL 1 discloses a projection system which can display an image having higher resolution than images formed by each image formation means on a projector by synthesizing two images formed by two image formation means. This projection system includes an image formation means which can form an image having low resolution, compared to an image displayed on a projector, and therefore the projection system can display an image having high resolution while preventing large scale or complicated image formation means.

### CITATION LIST

### Patent Literature

PTL 1: Japanese Unexamined Patent Application Publication No. 2009-141829

### SUMMARY OF INVENTION

### Technical Problem

However, as disclosed in PTL 1, the display device including the two image formation means may have a large scale and may cause an increase in manufacturing cost accompanied with an increase in the number of components, compared to a display device only including one image formation means.

In consideration of these circumstances, an object of the present invention is to provide a display device which can display an image having high resolution while preventing a large scale or high cost of the display device.

### Solution to Problem

The present invention provides a display device including: a first scanning line; two second scanning lines which are adjacent to the first scanning line and interpose the first scanning line; a first signal line and a second signal line which intersect with the first scanning line and the second scanning line and are adjacent to each other; a plurality of pixels which are provided to correspond to the intersection of the first scanning line and the second scanning line, and the first signal line and the second signal line; a first driving circuit which selects scanning lines of a first set configured with the first scanning lines and one second scanning line among the two second scanning lines in a first unit period, and selects scanning lines of a second set configured with the first scanning line and the other second scanning line among the two second scanning lines in a second unit period after the first unit period has elapsed; and a second driving circuit which supplies a first grayscale potential to a first pixel block which is four pixels corresponding to an intersection of the scanning lines of the first set, the first signal line, and the second signal line selected by the first driving circuit in the first unit period, and supplies a second grayscale potential to a second pixel block which is four pixels corresponding to an intersection of the scanning lines of the second set, the first signal line, and the second signal line selected by the first driving circuit in the second unit period.

In the configuration described above, the two scanning lines adjacent to each other are simultaneously selected and common grayscale potential is supplied to the four pixels adjacent to each other (first pixel block or second pixel block). Accordingly, it is possible to decrease the operation speed of the driving circuit (first driving circuit and second driving circuit), compared to a configuration of sequentially selecting the scanning line in each display period one by one and supplying the grayscale potential to each pixel. Accordingly, it is possible to decrease circuit scale and manufacturing cost of the driving circuit.

Normally, the grayscale potential supplied to the pixel is generated based on the image signal, but when it is not necessary to increase the operation speed of the driving circuit, it is also not necessary to increase the transfer speed of the image signal. Accordingly, it is possible to suppress the operation speed of the circuit generating the image signal to be low, compared to a configuration of sequentially selecting each scanning line one by one, and it is possible to decrease circuit scale and manufacturing cost of the circuit generating the image signal.

The resolution of the display image decreases when each of the first unit period and the second unit period ends, but in the second unit period, the image displayed in the first unit period is sequentially updated to the image to be displayed in the second unit period, and accordingly, it is advantageous that an observer hardly recognizes a decrease in resolution of the display image in each unit period.

The present invention provides a display device including: a first scanning line; two second scanning lines which are adjacent to the first scanning line and interpose the first scanning line; a first signal line which intersects with the first scanning line and the second scanning line; two second signal lines which intersect with the first scanning line and the second scanning line, are adjacent to the first signal line, and interpose the first signal line; a plurality of pixels which are provided to correspond to the intersection of the first scanning line and the second scanning line, and the first signal line and the second signal line; a first driving circuit which selects scanning lines of a first set configured with the first scanning lines and one second scanning line among the two second scanning lines in a first unit period, and selects scanning lines of a second set configured with the first scanning line and the other second scanning line among the two second scanning lines in a second unit period after the first unit period has elapsed; and a second driving circuit which supplies a first grayscale potential to a first pixel block which is four pixels corresponding to an intersection of the scanning lines of the first set selected by the first driving circuit and signal lines of the first set configured with the one second signal line among the two second signal lines and the first signal line in the first unit period, and supplies a second grayscale potential to a second pixel block which is four pixels corresponding to an intersection of the scanning lines of the second set selected by the first driving circuit and signal lines of the second set configured with the other second signal line among the two second signal lines and the first signal line in the second unit period.

In the configuration described above, since the two scanning lines adjacent to each other are simultaneously selected and the common grayscale potential is supplied to four pixels adjacent to each other, it is possible to decrease the transfer speed of the image signal or the operation speed of the driving circuit (first driving circuit and second driving circuit), compared to a configuration of sequentially selecting the scanning line in each display period one by one and supplying the grayscale potential to each pixel. Accordingly, it is possible to decrease circuit scale and manufacturing cost of the driving circuit. The resolution of the display image decreases when each of the first unit period and the second unit period ends, but in the second unit period, the image displayed in the first unit period is sequentially updated to the image to be displayed in the second unit period, and accordingly, it is advantageous that an observer hardly recognizes a decrease in resolution of the display image in each unit period.

The display device further includes a control circuit which controls the second driving circuit, the second driving circuit includes a signal supply circuit which outputs the first grayscale potential or the second grayscale potential, a first switch of which one end is electrically connected to the signal supply circuit and the other end is electrically connected to the first signal line, a second switch of which one end is electrically connected to the signal supply circuit and the other end is electrically connected to the one second signal line, a third switch of which one end is electrically connected to the signal supply circuit and the other end is electrically connected to the first signal line, and a fourth switch of which one end is electrically connected to the signal supply circuit and the other end is electrically connected to the other second signal line, the control circuit turns on the first switch and the second switch and turns off the third switch, the signal supply circuit outputs the first grayscale potential to one end of the first switch and one end of the second switch, in the first unit period, and the control circuit turns on the third switch and the fourth switch and turns off the first switch, and the signal supply circuit outputs the second grayscale potential to one end of the third switch and the one end of the fourth switch, in the second unit period.

In the display device described above, display data showing the grayscale to be displayed by the pixel is supplied to the control circuit, the control circuit calculates a weighted average of the grayscale designated by the display data as the grayscale to be displayed in each of four pixels belonging to the first pixel block, supplies a first image signal showing the calculated grayscale to the signal supply circuit, calculates a weighted average of the grayscale designated by the display data as the grayscale to be displayed in each of four pixels belonging to the second pixel block, and supplies a second image signal showing the calculated grayscale to the signal supply circuit, and the signal supply circuit which outputs the first grayscale potential when the first image signal is supplied, and outputs the second grayscale potential when the second image signal is supplied.

In the configuration described above, the grayscale potential corresponding to the grayscale calculated as the weighted average of the grayscale designated to each of four pixels by the display data is supplied to each of four pixels belonging to the block. Accordingly, it is possible to decrease a difference between the grayscale designated by a certain pixel in the first unit period and the grayscale designated in the second unit period, compared to a case in which the weight average of the grayscale designated by the display data is not acquired. That is, it is possible to decrease a possibility that an observer recognizes the difference between the grayscale designated by a certain pixel in the first unit period and the grayscale designated in the second unit period, as “flickering”.

In the display device described above, the control circuit sets weighting coefficients to be applied to the grayscale of each pixel in the calculation of the weighted average to a value larger than 0.

In the configuration described above, since the grayscale potential corresponding to the grayscale calculated as the weighted average of the grayscale designated to each of four pixels by the display data is supplied to the four pixels belonging to the block, it is possible to prevent the “flickering” due to a change in the grayscale displayed by the pixel.

In the display device described above, the control circuit sets weighting coefficients to be applied to the grayscale of each pixel in the calculation of the weighted average to an equivalent value.

In the configuration described above, the grayscale potential corresponding to the grayscale calculated as the simple average of the grayscale designated to each of four pixels by the display data is supplied to the four pixels belonging to the block, it is possible to simplify the configuration for preventing the “flickering” due to a change in the grayscale displayed by the pixel.

The display device described above may display a series of planar image.

In the configuration described above, it is possible to display the planar image having high resolution, without increasing the circuit scale and manufacturing cost of the driving circuit.

An electronic apparatus according to the present invention includes the display device described above. The electronic apparatus corresponds to a car navigation apparatus, a personal computer, a television, or a mobile phone.

### BRIEF DESCRIPTION OF DRAWINGS

FIG. 1 is a block diagram of a display device according to a first embodiment of the invention.

FIG. 2 is a circuit diagram of a pixel circuit.

FIG. 3 is an explanatory diagram of an operation of a display device.

FIG. 4 is an explanatory diagram of an operation of a scanning line driving circuit.

FIG. 5 is an explanatory diagram showing a block designated in each unit period.

FIG. 6 is an explanatory diagram illustrating a relationship between display data and grayscales displayed by a display device.

FIG. 7 is an explanatory diagram showing grayscales recognized by an observer.

FIG. 8 is a block diagram showing a configuration of a signal line driving circuit.

FIG. 9 is a timing chart for illustrating an operation of a signal line driving circuit.

FIG. 10 is an explanatory diagram schematically showing an operation of a selection circuit.

FIG. 11 is an explanatory diagram of an operation of a display device according to a second embodiment of the present invention.

FIG. 12 is an explanatory diagram showing a block designated in each unit period regarding a display device according to a second embodiment of the present invention.

FIG. 13 is an explanatory diagram illustrating calculation of a weighted average executed in a display device according to a modification example 4.

FIG. 14 is an explanatory diagram illustrating a relationship between grayscales displayed by a display device according to a modification example 4 and grayscales recognized by an observer.

FIG. 15 is a block diagram showing a configuration of a signal line driving circuit according to modification example 8.

FIG. 16 is a timing chart for illustrating an operation of a signal line driving circuit according to modification example 8.

FIG. 17 is a perspective view of an electronic apparatus (projection type display device).

FIG. 18 is a perspective view of an electronic apparatus (personal computer).

FIG. 19 is a perspective view of an electronic apparatus (mobile phone).

FIG. 20 is an explanatory diagram of an operation of a scanning line driving circuit according to a comparative example.

### DESCRIPTION OF EMBODIMENTS

### A. FIRST EMBODIMENT

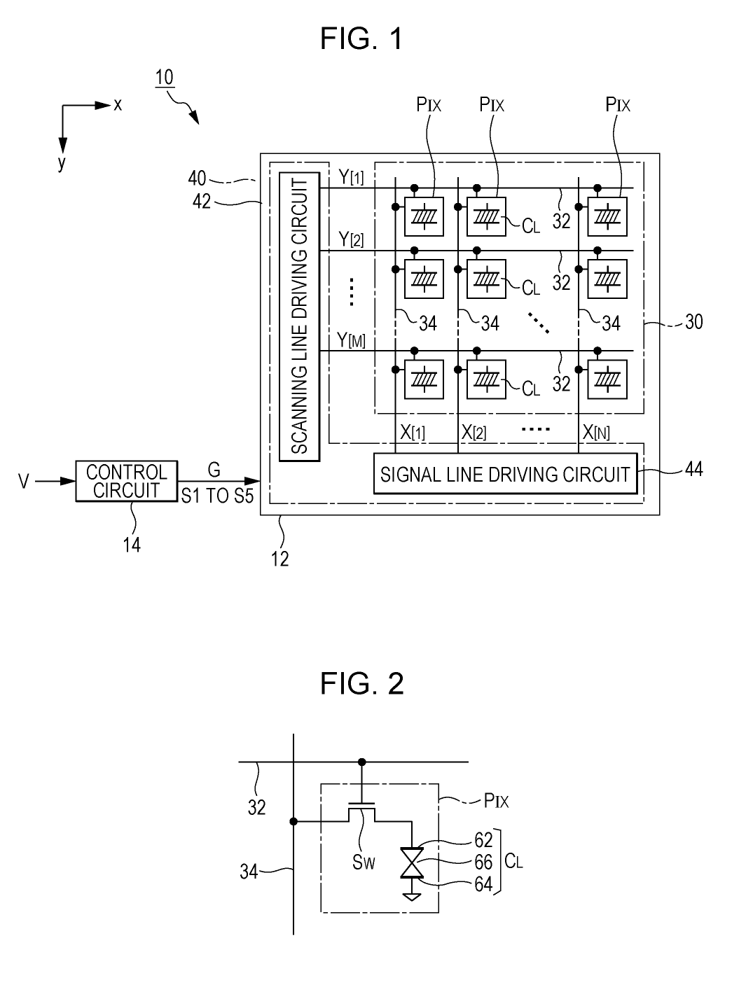

FIG. 1 is a block diagram of a display device 10 according to a first embodiment of the invention. The display device 10 is an electronic apparatus displaying a planar image and includes an electrooptical panel 12 and a control circuit 14.

The electrooptical panel 12 includes a pixel unit 30 in which a plurality of pixels (pixel circuits) PIX are arranged, and a driving circuit 40 which drives each pixel PIX. In the pixel unit 30, M scanning lines 32 which extend in an x direction and N signal lines 34 which extend in a y direction intersecting with the x direction are formed (M and N are natural numbers). The plurality of pixels PIX in the pixel unit 30 are arranged to have M vertical rows and N horizontal columns corresponding to each intersection of scanning lines 32 and signal lines 34. In the embodiment, the pixels PIX are disposed in all M×N intersections configured with M scanning lines 32 and N signal lines 34, but may be disposed some of M×N intersections.

The driving circuit 40 includes a scanning line driving circuit 42 (an example of a “first driving circuit”) and a signal line driving circuit 44 (an example of a “second driving circuit”).

The scanning line driving circuit 42 sequentially selects each scanning line 32 by supply of scanning signals Y[1] to Y[M] corresponding to each scanning line 32. The m-th scanning line 32 is selected by setting the scanning signal Y[m] (m=1 to M) to a predetermined selection potential.

The signal line driving circuit 44 supplies grayscale potentials X[1] to X[N] to each of N signal lines 34 in synchronization with selection of the scanning line 32 by the scanning line driving circuit 42. The grayscale potential X[n] (n=1 to N) is set to be variable according to the grayscales designated in each pixel PIX by an image signal G. A polarity of the grayscale potential X[n] corresponding to a predetermined reference potential is periodically reversed.

FIG. 2 is a circuit diagram of each pixel PIX. As shown in FIG. 2, each pixel PIX includes a liquid crystal element CL and a selection switch SW. The liquid crystal element CL is an electrooptical element configured with a pixel electrode 62 and a common electrode 64 facing each other and a liquid crystal 66 between both electrodes. Transmittance (display grayscale) of the liquid crystal 66 changes depending on an application potential between the pixel electrode 62 and the common electrode 64. A selection switch SW is, for example, configured with an N-channel type thin film transistor of which a gate is connected to the scanning line 32, and controls electrical connection (connection/insulation) between the liquid crystal element CL and the signal lines 34 by being interposed therebetween. The selection switches SW of each pixel PIX of the m-th row are simultaneously turned on by setting the scanning signal Y[m] to the selection potential. Each pixel PIX (liquid crystal element CL) displays the grayscale corresponding to the grayscale potential X[n] of the signal line 34 when the selection switch SW is controlled in the on state (that is, at the time of selection of the scanning line 32). In addition, auxiliary capacitance may be connected in parallel to the liquid crystal element CL.

As shown in FIG. 1, display data V designating the grayscale of each pixel PIX is supplied to the control circuit 14 from an external circuit. The control circuit 14 generates the image signal G based on the display data V and generates control signals S1 to S5 controlling the signal line driving circuit 44. The control circuit 14 controls the driving circuit 40 so as to execute the operation which will be described below.

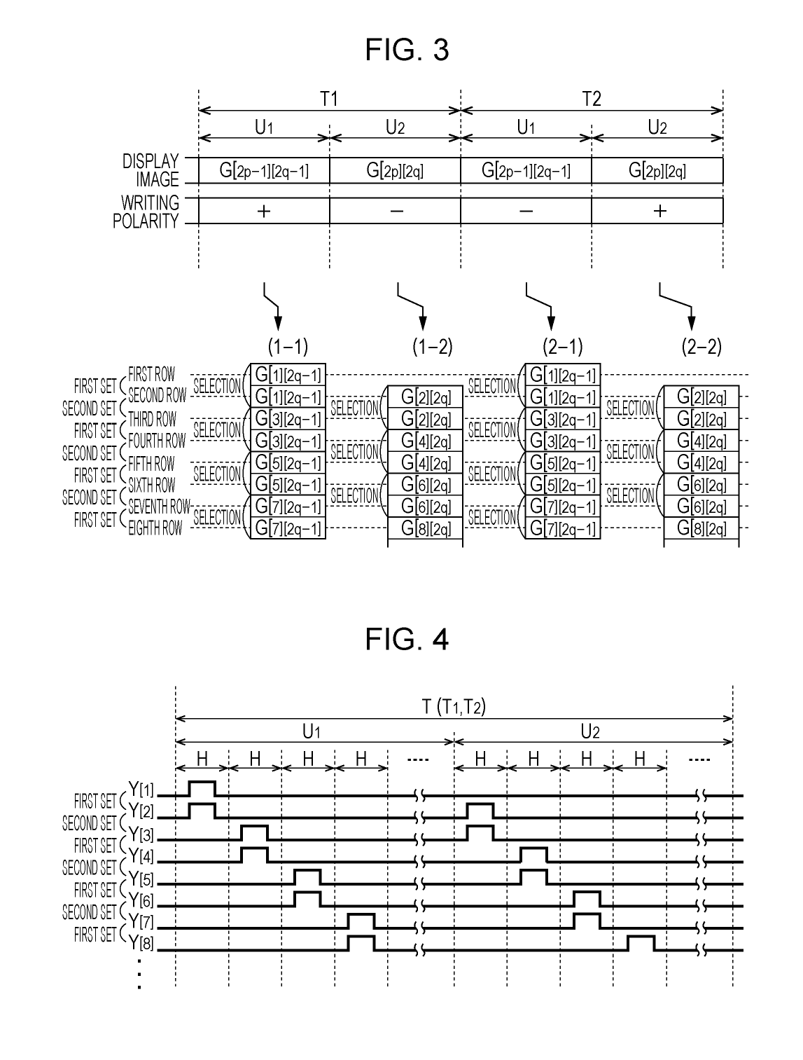

FIG. 3 is an explanatory diagram of the operation of the display device 10.

An operation period of the display device 10 is divided into a plurality of control periods T (T1 and T2). The control period T1 and control period T2 are alternately arranged on a time axis. Each control period T (T1 and T2) is divided into two unit periods U (U1 and U2) having a predetermined length. In each unit period U (U1 and U2), an image is displayed on the pixel unit 30 based on the image signal G. The unit period U1 and unit period U2 are alternately arranged on the time axis and the unit period U2 is follows the unit period U1 in each control period T (T1 and T2).

Hereinafter, the unit period U1 is referred to as a “first unit period” and the unit period U2 is referred to as a “second unit period”.

FIG. 4 shows the operation of the scanning line driving circuit 42. As shown in the drawing, in the unit period U1, the scanning line driving circuit 42 selects the scanning lines 32 of a plurality of sets obtained by setting M scanning lines 32 two by two adjacent to each other for each of the selection period H. More specifically, the scanning line driving circuit 42 sequentially selects the scanning lines 32 of a first set configured with one scanning line 32 in an even row ((2p)-th row) and one scanning line 32 of an odd row ((2p−1)-th row) adjacent to a negative side of the scanning line 32 in the y direction, in the unit period U1 (p is a natural number).

Hereinafter, the scanning line 32 in the even row is referred to as a “first scanning line” and the scanning line 32 in the odd row is referred to as a “second scanning line”.

In the embodiment, the scanning line 32 in the even row is referred to as the “first scanning line” and the scanning line 32 in the odd row is referred to as the “second scanning line”, but this is for convenience of the description, and the scanning line 32 in the odd row may be referred to as the “first scanning line” and the scanning line 32 in the even row may be referred to as the “second scanning line”. That is, the “first scanning line” may be one scanning line 32 in the even row or the odd row, and the “second scanning line” may be the other one scanning line 32 in the even row or the odd row.

The scanning line driving circuit 42 simultaneously selects the scanning line 32 of the first set by setting a scanning signal Y[2p−1] and a scanning signal Y[2p] to the selection potential in one selection period H in the unit period U1. For example, the two scanning lines 32 in the first row and the second row are simultaneously selected in the first selection period H in the unit period U1 and the two scanning lines 32 in the third row and the fourth row in the second selection period H in the unit period U1.

In the unit period U2, the scanning line driving circuit 42 selects the scanning line 32 of the plurality of sets obtained by setting M scanning lines 32 two by two adjacent to each other for each of the selection period H, with a combination different from that in the unit period U1. More specifically, the scanning line driving circuit 42 sequentially selects the scanning lines 32 of a first set configured with one scanning line 32 in an even row ((2p)-th row) and one scanning line 32 of an odd row ((2p+1)-th row) adjacent to a positive side of the scanning line 32 in the y direction, in the unit period U2 (p is a natural number). That is, the scanning line 32 of the first set and the scanning line 32 of the second set are in relationship shifted in the y direction by one scanning line 32.

The scanning line driving circuit 42 simultaneously selects the scanning line 32 of the second set by setting a scanning signal Y[2p] and a scanning signal Y[2p+1] to the selection potential in one selection period H in the unit period U2. For example, the two scanning lines 32 in the second row and the third row are simultaneously selected in the first selection period H in the unit period U2 and the two scanning lines 32 in the fourth row and the fifth row in the second selection period H in the unit period U2. For convenience of description, in the first embodiment, a case in which the scanning lines 32 in the first row and the M-th row are not selected in the unit period U2 is exemplified, but the scanning lines 32 in the first row and the M-th row can be selected in the unit period U2.

As described above, the scanning line driving circuit 42 selects the scanning lines 32 of the first set configured with the scanning line 32 in the even row ((2p)-th row) and the scanning line 32 in the odd row ((2p−1)-th row) which is one scanning line 32 among two scanning lines 32 in the odd rows adjacent to the scanning line 32 in the even row, in the unit period U1, and selects the scanning lines 32 of the second set configured with the scanning line 32 in the even row ((2p)-th row) and the scanning line 32 of the odd row ((2p+1)-th row) which is the other scanning line 32 among two scanning lines 32 in the odd rows adjacent to the scanning line 32 in the even row, in the unit period U2.

The signal line driving circuit 44 respectively supplies grayscale potentials X[1] to X[N] corresponding to the image signal G to the N signal lines 34, in each selection period H.

Although this will be described later in detail, the grayscale potentials are set to the potentials equivalent to the grayscale potential X[2q] and the grayscale potential X[2q−1] in the unit period U1 and these are simultaneously supplied to the signal line 34 in an odd column ((2q−1)-th column) and the signal line 34 in an even column ((2q)-th column).

More specifically, the signal line driving circuit 44 simultaneously supplies the common grayscale potential X[2q−1] (one example of a “first grayscale potential”) to the signal line 34 of a first set configured with one signal line 34 in an even column ((2q)-th column) and one signal line 34 in an odd column ((2q−1)-th column) adjacent to a negative side of the signal line 34 in the x direction, in the unit period U1 (q is a natural number).

In addition, the signal line driving circuit 44 simultaneously supplies the common grayscale potential X[2q] (one example of a “second grayscale potential”) to the signal line 34 of a second set configured with one signal line 34 in an even column ((2q)-th column) and one signal line 34 in an odd column ((2q+1)-th column) adjacent to a positive side of the signal line 34 in the x direction, in the unit period U2.

That is, the signal line driving circuit 44 selects the signal lines 34 of the first set configured with the signal line 34 in the even column ((2q)-th column) and the signal line 34 in the odd column ((2q−1)-th column) which is one signal line 34 among two signal lines 34 in the odd columns adjacent to the signal line 34 in the even column, in the unit period U1, and selects the signal lines 34 of the second set configured with the signal line 34 in the even column ((2q)-th column) and the signal line 34 in the odd column ((2q+1)-th column) which is the other signal line 34 among two signal lines 34 in the odd columns adjacent to the signal line 34 in the even column, in the unit period U2.

Hereinafter, the signal line 34 in the even column is referred to as a “first signal line” and the signal line 34 in the odd column is referred to as a “second signal line”.

In the embodiment, the signal line 34 in the even column is referred to as the “first signal line” and the signal line 34 in the odd column is referred to as the “second signal line”, but this is for convenience of the description, and the signal line 34 in the odd column may be referred to as the “first signal line” and the signal line 34 in the even column may be referred to as the “second signal line”. That is, the “first signal line” may be one signal line 34 in the even column or the odd column, and the “second signal line” may be the other signal line 34 in the even column or the odd column.

FIG. 3 shows a time change of a polarity (writing polarity) of each grayscale potential X[n] with respect to a predetermined reference potential (for example, potential of the common electrode 64). Since the grayscale potential X[n] is supplied to the pixel electrode 62 of the liquid crystal element CL, the polarity shown in FIG. 3 can be identified as a polarity of the application potential with respect to the liquid crystal element CL.

As shown in FIG. 3, the signal line driving circuit 44 reverses the polarity of the grayscale potential X[n] for each unit period U (U1 and U2) in each control period T and sets the grayscale potentials X[n] in each unit period U to have the reversed polarity in each successive control period T. Specifically, in the control period T1, the polarity of the grayscale potential X[n] is set to a positive polarity (+) in the unit period U1 and is set to a negative polarity (−) in the unit period U2. Meanwhile, in the control period T2 immediately after the control period T1, the polarity of the grayscale potential X[n] is set to a negative polarity (−) in the unit period U1 and is set to a positive polarity (+) in the unit period U2.

Hereinafter, a relationship between the display data V, the image signal G, and the grayscale potential X[n] will be described. In the following description, the grayscale designated to the pixel PIX in the m-th row and the n-th column by the display data V is represented as a grayscale V[m][n]. In addition, the grayscale designated to the pixel PIX in the m-th row and the n-th column by the image signal G is represented as a grayscale G[m][n].

In the selection period H in which two scanning lines 32 in the (2p−1)-th row and the (2p)-th row configuring the scanning lines 32 of the first set are selected, from the unit period U1 in each control period T (T1 and T2), a grayscale G[2p−1][2q−1] designated to the pixel PIX in the (2p−1)-th row and the (2q−1)-th column by the image signal G is calculated as a weighted average of a grayscale V[2p−1][2q−1] designated to the pixel PIX in the (2p−1)-th row and the (2q−1)-th column, a grayscale V[2p][2q−1] designated to the pixel PIX in the (2p)-th row and the (2q−1)-th column, a grayscale V[2p−1][2q] designated to the pixel PIX in the (2p−1)-th row and the (2q)-th column, and a grayscale V[2p][2q] designated to the pixel PIX in the (2p)-th row and the (2q)-th column by the display data V.

More specifically, the grayscale G[2p−1][2q−1] is determined by the following equation (1).

G[2p−1][2q−1]={(w_{2p-1,2q-1}×V[2p−1][2q−1])+(w_{2p,2q-1}×V[2p][2q−1])+(w_{2p-1,2q}×V[2p−1][2q])+(w_{2p,2q}×V[2p][2q])}/{w_{2p-1,2q-1}+w_{2p,2q-1}+w_{2p-1,2q}+w_{2p,2q}} Equation (1)

Herein, four weighting coefficients w_{m, n} in the equation (1) are real numbers greater than “0”. In a case where a calculation result on the right side of the equation (1) is not an integer, the grayscale G[2p−1][2q−1] may be calculated by further executing the calculation such as rounding off or rounding down after the decimal places with respect to the calculation result on the right side of the equation (1). In the embodiment, each of the four weighting coefficients w_{m,n} is set to an equivalent value, for example, “1”. That is, in the embodiment, as shown in the following equation (2), the grayscale G[2p−1][2q−1] is calculated as a simple average (arithmetical mean) of a grayscale designated to each of four pixels PIX by the display data V.

G[2p−1[]2q−1]={V[2p−1[]2q−1]+V[2p][2q−1]+V[2p−1][2q]+V[2p][2q]}/4 Equation (2)

As described above, the signal line driving circuit 44 commonly supplies the grayscale potential X[2q−1] corresponding to the grayscale G[2p−1][2q−1] to two signal lines 34 in the (2q−1)-th column and the (2q)-th column (signal lines 34 of the first set). Accordingly, the grayscale potential X corresponding to the grayscale G[2p−1][2q−1] is commonly supplied to four pixels PIX which are adjacent to each other and are positioned in the (2p−1)-th row and the (2q−1)-th column, the (2p−1)-th row and the (2q)-th column, the (2p)-th row and the (2q−1)-th column, and the (2p)-th row and the (2q)-th column.

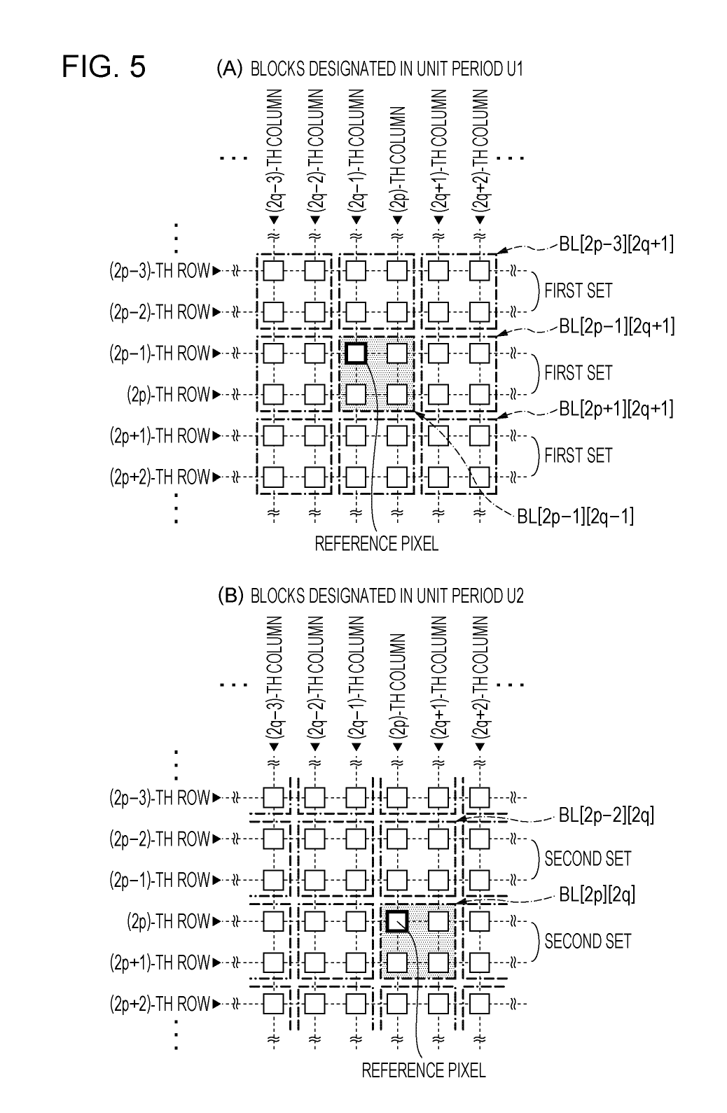

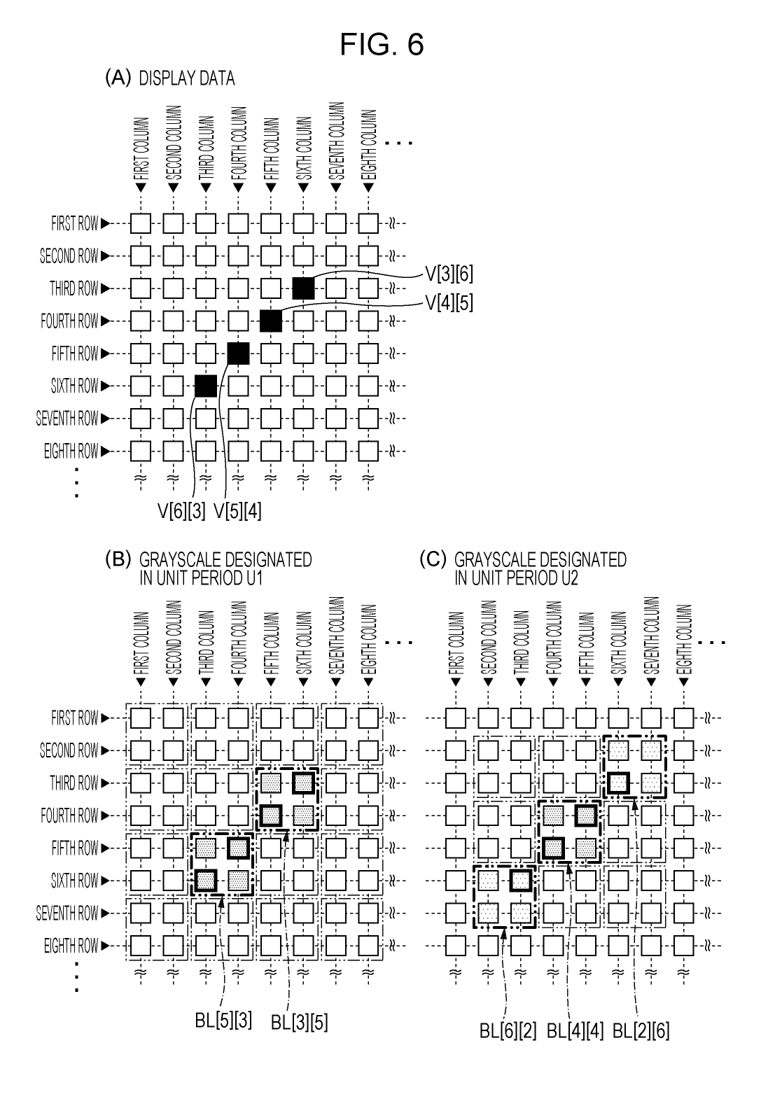

Herein, as shown in FIG. 5(A), in the unit period U1, a pixel PIX[2p−1][2q−1] in the odd row and the odd column is set as a “reference pixel”, and four pixels PIX configured with a reference pixel, a pixel PIX in the odd row and the even column adjacent to a positive side of the reference pixel in the x direction, a pixel PIX in the even row and the odd column adjacent to a positive side of the reference pixel in the y direction, and a pixel PIX in the even row and the even column obtained by shifting the reference pixel to a positive side in the x direction and to a positive side in the y direction by one pixel, are set as a “block”. The grayscale potential X corresponding to the grayscale designated to the reference pixel by the image signal G is commonly supplied to the four pixels PIX belonging to the block. Hereinafter, the block including the pixel PIX in the m-th row and the n-th column as a reference pixel is shown as a block BL[m][n].

For example, as shown in a part (1-1) and a part (2-1) of FIG. 3, in the first selection period H in the unit period U1, the grayscale potential X corresponding to the grayscale G[1][2q−1] is commonly supplied to the four pixels PIX belonging to the block BL[1][2q−1] (block BL including the odd column of the first row as a reference pixel). In the second selection period H in the unit period U1, the grayscale potential X corresponding to the grayscale G[3][2q−1] is commonly supplied to the four pixels PIX belonging to the block BL[3][2q−1] (block BL including the odd column of the third row as a reference pixel).

As described above, in the unit period U1, among the plurality of pixels PIX disposed in M vertical rows and N horizontal columns, the plurality of block BL[2p−1][2q−1] corresponding to each of the plurality of reference pixels is designated by setting each of the plurality of pixels PIX[2p−1][2q−1] positioned in the odd row and the odd column as a reference pixel. The common grayscale potential X is supplied to each of four pixels PIX belonging to each block BL[2p−1][2q−1] designated in the unit period U1. Accordingly, in the time point when the unit period U1 ends, an image having the resolution of an image shown by the display data V and to be displayed in the x direction decreased to half and the resolution thereof in the y direction decreased to half, is displayed on the pixel unit 30.

Hereinafter, the block BL[2p−1][2q−1] designated in the unit period U1 may be referred to as a “first pixel block” and the reference pixel PIX[2p−1][2q−1] of the block BL may be referred to as a “first reference pixel”.

As shown in FIG. 5(B), in the unit period U2 in each control period T (T1 and T2), regarding the block BL designated in the unit period U1, four pixels PIX shifted in the x direction and the y direction by one pixel are designated as the block BL. That is, in the unit period U2, the block BL[2q][2q] including the pixel PIX[2q][2q] as a reference pixel is designated.

Hereinafter, the block BL[2q][2q] designated in the unit period U2 may be referred to as a “second pixel block” and the reference pixel PIX[2q][2q] of the block BL may be referred to as a “second reference pixel”.

The grayscale potential X corresponding to the common grayscale is supplied to the four pixels PIX belonging to the block BL[2q][2q] designated in the unit period U2.

More specifically, in the selection period H in which two scanning lines 32 in the(2p)-th row and the (2p+1)-th row configuring the scanning lines 32 of the second set are selected, from the unit period U2 in each control period T (T1 and T2), a grayscale G[2q][2q] designated to the four pixels PIX belonging to the block BL[2q][2q] by the image signal G is determined as a weighted average of the grayscale V[2q][2q] designated to the pixel PIX in the (2p)-th row and the (2q)-th column, a grayscale V[2p+1][2q] designated to the pixel PIX in the (2p+1)-th row and the (2q)-th column, a grayscale V[2p][2q+1] designated to the pixel PIX in the (2p)-th row and the (2q+1)-th column, and a grayscale V[2p+1][2q+1] designated to the pixel PIX in the (2p+1)-th row and the (2q+1)-th column by the display data V, by the following equation (3).

G[2p][2q]={(w_{2p,2q}×V[2p][2q])+(w_{2p+1,2q}×V[2p+1][2q])+(w_{2p,2q-1}×V[2p][2q+1)+(w_{2p+1,2q+1}×V[2p+1][2q+1])}/{w_{2p,2q}×w_{2p+1,2q}+w_{2p,2q+1}+w_{2p+1,2q+1}} Equation (3)

Herein, four weighting coefficients w in the equation (3) are real numbers greater than “0”. In the embodiment, each of the four weighting coefficients w is set to an equivalent value, for example, “1”. That is, in the embodiment, as shown in the following equation (4), the grayscale G[2q][2q] is calculated as a simple average (arithmetical mean) of a grayscale designated to each of four pixels PIX belonging to the block BL[2q][2q] by the display data V.

G[2p][2q]={V[2p][2q]+V[2p+1][2q]+V[2p][2q+1]+V[2p+1][2q+1]}/4 Equation (4)

As described above, the signal line driving circuit 44 commonly supplies the grayscale potential X[2q] corresponding to the grayscale G[2q][2q] to the two signal lines 34 in the (2q)-th column and the (2q+1)-th column (signal line 34 of the second set). Accordingly, the grayscale potential X corresponding to the grayscale G[2q][2q] is commonly supplied to four pixels PIX which are adjacent to each other and are positioned in the (2p)-th row and the (2q)-th column, the (2p+1)-th row and the (2q)-th column, the (2p)-th row and the (2q+1)-th column, and the (2p+1)-th row and the (2q+1)-th column belonging to the block BL[2p][2q].

For example, as shown in a part (1-2) and a part (2-2) of FIG. 3, in the first selection period H in the unit period U2, the grayscale potential X corresponding to the grayscale G[2][2q] is commonly supplied to the four pixels PIX belonging to the block BL[2][2q] (block BL including the even column of the second row as a reference pixel). In the second selection period H in the unit period U2, the grayscale potential X corresponding to the grayscale G[4][2q] is commonly supplied to the four pixels PIX belonging to the block BL[4][2q] (block BL including the odd column of the fourth row as a reference pixel).

As described above, in the unit period U2, among the plurality of pixels PIX disposed in M vertical rows and N horizontal columns, the plurality of block BL[2q][2q] corresponding to each of the plurality of reference pixels is designated by setting each of the plurality of pixels PIX[2q][2q] positioned in the even row and the even column as a reference pixel. The common grayscale potential X is supplied to each of four pixels PIX belonging to each block BL[2q][2q] designated in the unit period U2. Accordingly, in the time point when the unit period U2 ends, an image having the resolution of an image shown by the display data V and to be displayed in the x direction decreased to half and the resolution thereof in the y direction decreased to half, is displayed on the pixel unit 30.

In a configuration of setting the M-th row and the first row in each unit period U, the grayscale potential X[n] of a predetermined potential (for example, a potential corresponding to a halftone) is supplied to each signal line 34 in the selection period H in which the first row and the M-th row are selected, for example.

As described bove, in the first embodiment, the common grayscale potential X is supplied to four pixels PIX belonging to the block BL designated in each unit period U (U1 and U2).

Hereinafter, the grayscale designated to each pixel PIX by the image signal G in the unit period U1 is referred to as a first set grayscale and the grayscale designated to each pixel PIX by the image signal G in the unit period U2 is referred to as a second set grayscale. Among the image signals G, the image signal G which designates the grayscale of each pixel PIX in the unit period U1 is referred to as a first grayscale signal and the image signal G which designates the grayscale of each pixel PIX in the unit period U2 is referred to as a second grayscale signal.

In the unit period U1 and the unit period U2, an image having the resolution decreased to half in the x direction and the y direction of the original display image shown by the display data V is displayed.

However, the image displayed for each block BL[2p−1][2q−1] according to the grayscale G[2p−1][2q−1] in the unit period U1 is sequentially updated to an image displayed for each block BL[2q][2q] according to the grayscale G[2q][2q] in the previous and subsequent unit periods U2. That is, an image displayed in the previous unit period U1 and an image displayed in the unit period U2 are mixed in the unit period U2. In the same manner as described above, an image displayed in the previous unit period U2 and an image displayed in the unit period U1 are mixed in the unit period U1. Accordingly, it is advantageous that an observer hardly recognizes a decrease in resolution of the display image in each unit period U.

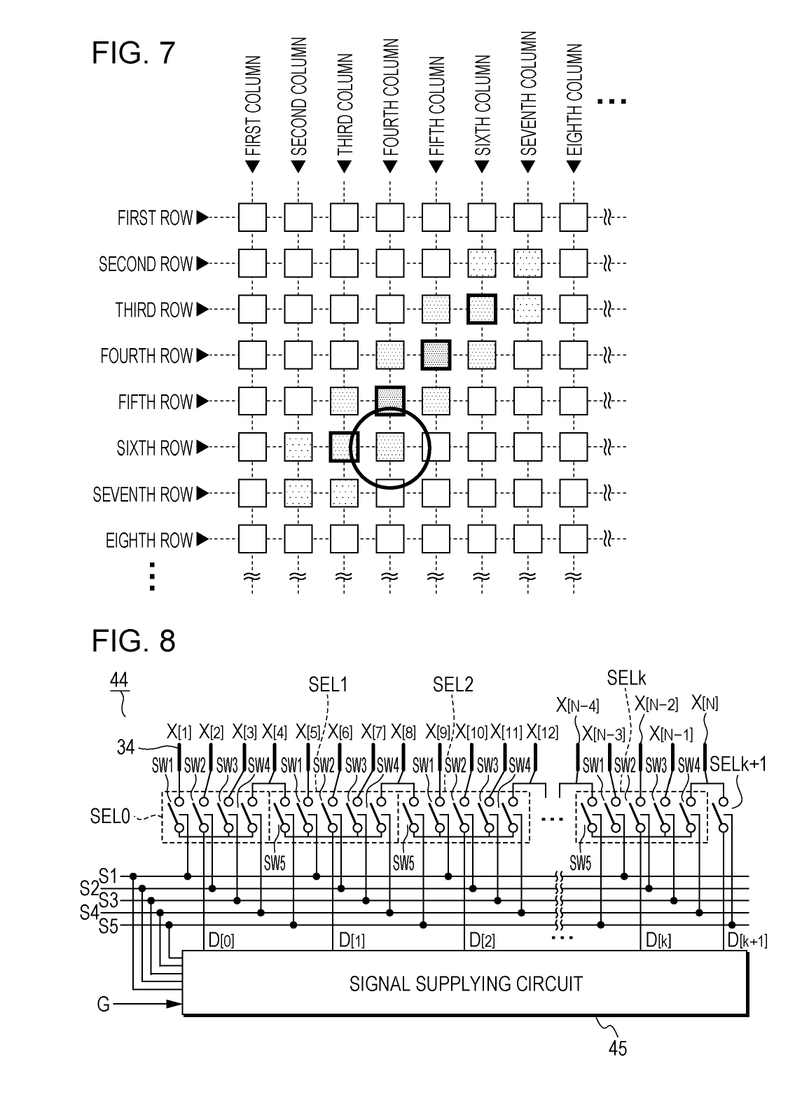

Herein, with reference to FIG. 6 and FIG. 7, an image actually recognized by an observer when the image displayed in the unit period U1 and the image displayed in the unit period U2 are mixed, will be described. For convenience of the drawing, FIG. 6 and FIG. 7 illustratively show 64 pixels PIX in the eight vertical rows of the first to eighth rows and eight horizontal columns of the first to eighth columns, among the plurality of pixels PIX arranged in matrix of the vertical M row and the horizontal N column.

FIG. 6 is an explanatory diagram showing a relationship between the display data supplied to the control circuit 14 from an external circuit and the image signal G generated by the control circuit 14.

FIG. 6(A) is an explanatory diagram showing a size of the grayscale V[m][n] designated to each pixel PIX by the display data V supplied from an external circuit with shading. In this example, when the grayscale designated by the display data V is a maximum grayscale, the pixel PIX is shown in while, when the grayscale is a minimum grayscale, the pixel PIX is shown in black, and when the grayscale is an intermediate grayscale between the maximum grayscale and the minimum grayscale, the pixel PIX is shown in a middle color between white and black (for example, gray). In this example, regarding the display data V, the grayscales V[6][3], V[5][4], V[4][5], and V[3][6] are set to the minimum grayscale (shown in black in the drawing), and the grayscales V other than these four are set to the minimum grayscale (shown in white in the drawing).

FIG. 6(B) shows a size of the grayscale designated to each pixel PIX in the unit period U1 by the image signal G output by the control circuit 14, when the display data V shown in FIG. 6(A) is supplied to the control circuit 14 by an external circuit, and FIG. 6(C) is an explanatory diagram showing a size of the grayscale designated to each pixel PIX in the unit period U2 by the image signal G. In the same manner as in FIG. 6(A), FIG. 6(B) and FIG. 6(C) also show a size of the grayscale designated to each pixel PIX by the image signal G.

As shown in FIG. 6(B), in the unit period U1, since the grayscale G[5][3] designated by the image signal G of the four pixels PIX belonging to the block BL[5][3] including the pixel PIX[5][3] in the fifth row and the third column as a reference pixel is an average of the grayscales V[5][4] and V[6][3] which are the minimum grayscales and the grayscales V[5][3] and V[4][4] which are the maximum grayscales, the grayscale G[5][3] is the intermediate grayscale (gray in the drawing). In the same manner as described above, the grayscale G[3][5] designated by the image signal G of the four pixels PIX belonging to the block BL[3][5] is also the intermediate grayscale (gray in the drawing). The image signal G of the other blocks (BL[1][1], BL[1][3], BL[1][5], BL[1][7], BL[3][1], BL[3][3], BL[3][7], BL[5][1], BL[5][5], BL[5][7], BL[7][1], BL[7][3], BL[7][5], and BL[7][7]) designates the maximum grayscale.

As shown in FIG. 6(C), in the unit period U2, since the grayscale G[4][4] designated by the image signal G of the four pixels PIX belonging to the block BL[4][4] is an average of the grayscales V[5][4] and V[4][5] which are the minimum grayscales and the grayscales V[4][4] and V[5][5] which are the maximum grayscales, the grayscale G[4][4] is the intermediate grayscale (gray in the drawing). In addition, since the grayscale G[6][2] designated by the image signal G of the four pixels PIX belonging to the block BL[6][2] is an average of the grayscale V[6][3] which is the minimum grayscale and the grayscales V[6][2], V[7][2], and V[7][3] which are the maximum grayscales, the grayscale G[6][2] is a grayscale between the intermediate grayscale and the maximum grayscale (middle color of gray and white in the drawing). In the same manner as described above, the grayscale G[2][6] designated by the image signal G of the four pixels PIX belonging to the block BL[2][6] is also the grayscale between the intermediate grayscale and the maximum grayscale (middle color of gray and white in the drawing). As shown in FIG. 6(C), the image signal G designates the maximum grayscale of the other blocks.

In the unit period U2, an observer recognizes the image obtained by mixing the image displayed in the unit period U1 and the image displayed in the unit period U2.

FIG. 7 is an explanatory diagram showing a grayscale actually recognized by an observer in the unit period U2, when the display data V shown in FIG. 6(A) is supplied by an external circuit. For example, as shown in FIG. 6(B), with respect to the pixel PIX positioned in the sixth row and the fourth column, the grayscale potential X[n] corresponding to the grayscale G[5][3] (first set grayscale) which is the intermediate grayscale (gray in the drawing) is supplied in the unit period U1, and as shown in FIG. 6(C), the grayscale potential X[n] corresponding to the grayscale G[6][4] (second set grayscale) which is the maximum grayscale (gray in the drawing) is supplied in the unit period U2. Accordingly, as shown in FIG. 7, the pixel PIX positioned in the sixth row and the fourth column is recognized by an observer as a pixel displaying the grayscale (middle color of gray and white in the drawing) between the maximum grayscale and the maximum grayscale.

In the strict sense, the grayscale of the pixel PIX recognized by an observer is determined based on the position of the pixel unit 30 of the pixel PIX, in addition to the first set grayscale and the second set grayscale designated to the pixel PIX.

Specifically, duration of a period in which a period displaying the first set grayscale designated in the pixel PIX positioned in the m-th row in the unit period U1, and the unit period U2 are overlapped (that is, a period displaying the first set grayscale by the pixel PIX in the unit period U2) is set as duration s1[m], and duration of a period in which a period displaying the second set grayscale designated in the pixel PIX in the unit period U2, and the unit period U2 are overlapped, (that is, a period displaying the second set grayscale by the pixel PIX in the unit period U2) is set as duration s2[m]. At that time, the pixel PIX is recognized by an observer as a pixel displaying the grayscale corresponding to the weighted average of the first set grayscale and the second set grayscale using the duration s1 and the duration s2 as the weights.

The duration s1[m] is decreased when the pixel PIX is positioned on the upper portion of the pixel unit 30 (negative side in the Y direction). In this case, the pixel PIX is recognized by an observer as a pixel displaying the grayscale closer to the first set grayscale, than the second set grayscale.

Next, the specific configuration of the signal line driving circuit 44 will be described. FIG. 8 shows a block diagram of the signal line driving circuit 44.

The signal line driving circuit 44 includes k+2 selection circuits SEL0 to SELk+1. Herein, k is a natural number equal to or larger than 2. Among those, k selection circuits SEL1 to SELk include one input terminal, five output terminals, and five switches. The five output terminals are connected to five signal lines 34. In addition, the selection circuit SEL0 includes one input terminal, four output terminals, and four switches. Further, the selection circuit SELk+1 includes one switch. The on and off state of switches SW1 to SW5 provided in the selection circuits SEL0 to SELk+1 is controlled by the control signals S1 to S5. Specifically, when the control signal S1 is in an active state (high level), the switch SW1 is turned on, when the control signal S2 is in an active state, the switch SW2 is turned on, when the control signal S3 is in an active state, the switch SW3 is turned on, when the control signal S4 is in an active state, the switch SW4 is turned on, and when the control signal S5 is in an active state, the switch SW5 is turned on.

In the embodiment, the switch SW4 is referred to as a “first switch”, the switch SW3 is referred to as a “second switch”, the switch SW5 is referred to as a “third switch”, and the switch SW1 is referred to as a “fourth switch”.

A signal supply circuit 45 generates data signal D[0] to D[k+1] based on the image signal G and the control signals S1 to S5. Among these, k+1 data signals D[0] to D[k] are obtained by time division multiplex of the grayscale potential supplied to pixels of four columns. The selection circuits SEL0 to SELk have a function of distributing the grayscale potential obtained by decoding the data signals D[0] to D[k] subjected to the time division multiplex, to the pixels of four columns.

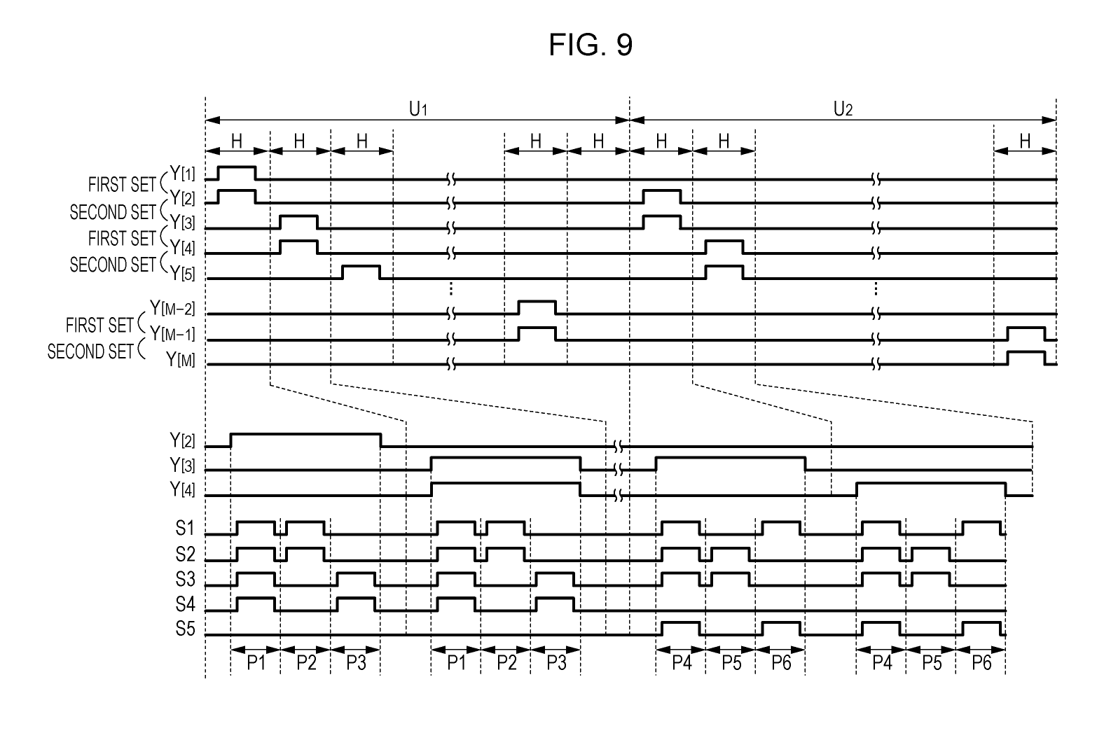

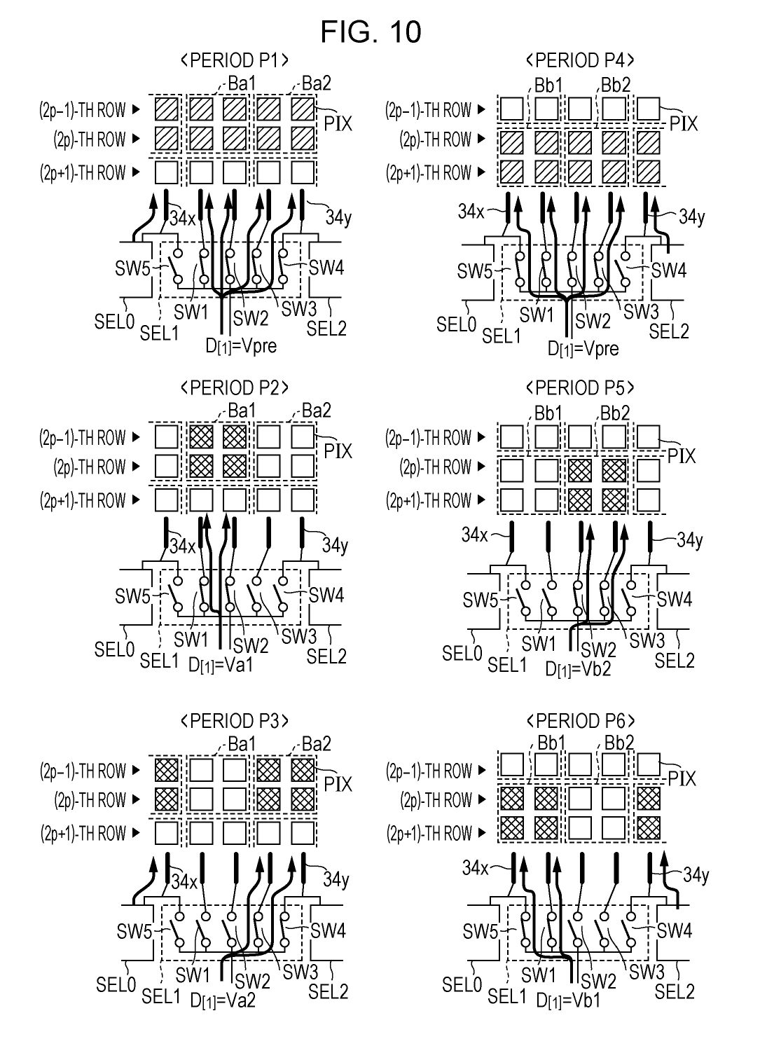

FIG. 9 shows a timing chart of the signal line driving circuit 44 and FIG. 10 schematically shows the operation of the selection circuit SEL1.

First, in the unit period U1, the scanning signal Y[2p−1] and the scanning signal Y[2p] are simultaneously turned into an active state as the scanning signals Y[1] and Y[2] as shown in FIG. 9 and the scanning lines 32 of the first set are simultaneously selected.

In the unit period U1, a period P1, a period P2, and a period P3 are set in the period in which the scanning lines 32 of the first set are simultaneously selected. Among these, the period P1 is a period in which a precharge potential Vpre is supplied to the signal line 34. The period P2 and the period P3 are a period in which the grayscale potential is supplied to four pixels belonging to the block.

In the period P1, the control signals S1 to S4 are turned into an active state and the control signal S5 is turned into an inactive state. Accordingly, as shown in FIG. 10, the precharge potential Vpre is written in the pixel PIX of blocks Ba1 and Ba2 through the switches SW1 to SW4. The precharge potential Vpre is set to the potential at which the writing of the grayscale potential is easy in the period P2 and the period P3, and the precharge potential may be a potential corresponding to the intermediate grayscale, for example.

Next, in the period P2, as shown in FIG. 9, the control signals S1 and S2 are turned into an active state and the control signals S3 to S5 are turned into an inactive state. Accordingly, as shown in FIG. 10, the grayscale potential Va1 is written in the pixel PIX of the block Ba1 through the switches SW1 and SW2.

Next, in the period P3, as shown in FIG. 9, the control signals S3 and S4 are turned into an active state and the control signals S1, S2, and S5 are turned into an inactive state. Accordingly, as shown in FIG. 10, the grayscale potential Va2 is written in the pixel PIX of the block Ba2 through the switches SW3 and SW4.

That is, in the period P3 of the unit period U1, the control circuit 14 turns on the switch SW3 and the switch SW4 and turns off the switch SW1. Accordingly, in the period P3 of the unit period U1, the common grayscale potential Va2 is supplied to the pixel PIX of the block Ba2 provided corresponding to the signal line 34 of the first set to which the switch SW3 and the switch SW4 are connected.

Also in the period P2 of the unit period U1, the control circuit 14 controls the signal line driving circuit 44 so that the common grayscale potential Va1 is supplied to the pixel PIX of the block Ba1 provided corresponding to the signal line 34 of the first set.

Meanwhile, in the unit period U2, the scanning signal Y[2p] and the scanning signal Y[2p+1] are simultaneously turned into an active state as the scanning signals Y[2] and Y[3] as shown in FIG. 9 and the scanning lines 32 of the second set are simultaneously selected.

In the unit period U2, a period P4, a period P5, and a period P6 are set in the period in which the scanning lines 32 of the second set are simultaneously selected. Among these, the period P4 is a period in which the precharge potential Vpre is supplied to the signal line 34. The period P5 and the period P6 are a period in which the grayscale potential is supplied to four pixels belonging to the block.

In the period P4, the control signals S1 to S3 and S5 are turned into an active state and the control signal S4 is turned into an inactive state. Accordingly, as shown in FIG. 10, the precharge potential Vpre is written in the pixel PIX of blocks Ba1 and Ba2 through the switches SW1 to SW3 and SW5.

Next, in the period P5, as shown in FIG. 9, the control signals S2 and S3 are turned into an active state and the control signals S1, S4, and S5 are turned into an inactive state. Accordingly, as shown in FIG. 10, the grayscale potential Vb2 is written in the pixel PIX of the block Bb2 through the switches SW2 and SW3.

Next, in the period P6, as shown in FIG. 9, the control signals S1 and S5 are turned into an active state and the control signals S2 to S4 are turned into an inactive state. Accordingly, as shown in FIG. 10, the grayscale potential Vb1 is written in the pixel PIX of the block Bb1 through the switches SW1 and SW5.

That is, in the period P6 of the unit period U2, the control circuit 14 turns on the switch SW1 and the switch SW5 and turns off the switch SW4. Accordingly, in the period P6 of the unit period U2, the common grayscale potential Vb1 is supplied to the pixel PIX of the block Bb1 provided corresponding to the signal line 34 of the second set to which the switch SW1 and the switch SW5 are connected.

Also in the period P5 of the unit period U2, the control circuit 14 controls the signal line driving circuit 44 so that the common grayscale potential Vb2 is supplied to the pixel PIX of the block Bb2 provided corresponding to the signal line 34 of the second set.

A signal line 34x shown in FIG. 10 is positioned on the boundary of two selection circuit SEL0 and selection circuit SEL1 adjacent to each other and a signal line 34y is positioned on the boundary of two selection circuit SEL1 and selection circuit SEL2 adjacent to each other. In the following description, the signal line 34 positioned on the boundary of the two selection circuits adjacent to each other is referred to as a common signal line. The common signal line 34x is connected to the selection circuit SEL0 and selection circuit SEL1 and the common signal line 34y is connected to the selection circuit SEL1 and selection circuit SEL2.

When focusing on the common signal line 34x, in the unit period U1, the common signal line 34x is selected by one selection circuit SEL0 among the two selection circuit SEL0 and the selection circuit SEL1 adjacent to each other, and the common signal line 34x is not selected by the other selection circuit SEL1. Meanwhile, in the unit period U2, the common signal line 34x is selected by the other selection circuit SEL1, and the common signal line 34x is not selected by one selection circuit SEL0.

When focusing on the common signal line 34y, in the unit period U1, the common signal line 34y is selected by one selection circuit SEL1 among the two selection circuit SEL1 and the selection circuit SEL2 adjacent to each other, and the common signal line 34y is not selected by the other selection circuit SEL2. Meanwhile, in the unit period U2, the common signal line 34y is selected by the other selection circuit SEL2, and the common signal line 34x is not selected by one selection circuit SEL1.

As described above, each of the common signal lines 34x and 34y is connected to the selection circuits adjacent to each other, and in the unit periods U1 and U2, the signal line 34 supplying the same grayscale potential is switched by switching the selection circuit selecting these. As a result, in the unit periods U1 and U2, the pixel PIX configuring the block can be horizontally shifted by one pixel.

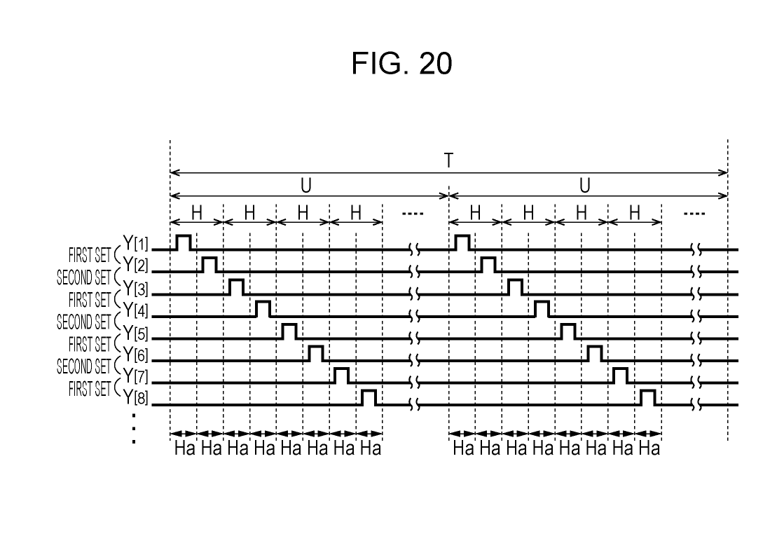

For describing the effect of the embodiment, as the example shown in FIG. 20, a configuration of updating the display image using the unit period U as a cycle (hereinafter, referred to as a “comparative example”) will be described.

As the example shown in FIG. 20, in a case of a configuration of updating the display image using the unit period U as a cycle, it is necessary for the scanning line driving circuit to select the M scanning lines for each selection period Ha one by one. In a case of the example shown in FIG. 20, in the unit period U, it is necessary for the signal line driving circuit to supply the grayscale potentials X[m][1] to X[m][N] corresponding to the N grayscales V[m][1] to grayscales V[m][N].

With respect to this, in the embodiment, the scanning lines 32 are selected in a unit of two and the grayscale potential X[n] is supplied to each pixel PIX in the unit period U1 and the unit period U2 of the control period T (T1 and T2). In each selection period H, the common grayscale potential X[n] is simultaneously supplied to the two signal lines 34 adjacent to each other. The selection period H has duration which is approximately two times of the selection period Ha shown in the comparative example. Accordingly, it is possible to suppress the operation speed of the control circuit 14 and the driving circuit 40 or the transfer speed of the display data V and the image signal G approximately to a half value of the configuration according to the comparative example for updating the display image using the unit period U (U1 and U2) as a cycle. That is, the display device 10 according to the embodiment has an advantage of decreasing circuit scale and manufacturing cost of the driving circuit.

In the embodiment, as shown in FIG. 3, the grayscale potential X[n] corresponding to the grayscales G[2p−1][2q−1] designated by the image signal G is set to the positive polarity in the unit period U1 of the control period T1 and is set to the negative polarity in the unit period U1 of the control period T2. In the same manner as described above, even regarding the grayscale G[2q][2q] designated in the unit period U2 of the image signal G, the duration in which the grayscale potential X[n] is set to the positive polarity and the duration in which the grayscale potential is set to the negative polarity are equalized. Accordingly, it is possible to suppress application of DC component to the liquid crystal element CL (it is possible to suppress degradation of the liquid crystal element CL).

In the embodiment, as described above, in the unit period U2, the image displayed in the unit period U1 immediately before the unit period U2 and the image displayed in the unit period U2 are mixed. In the same manner as described above, in the unit period U1, the image displayed in the unit period U2 immediately before the unit period U1 and the image displayed in the uit period U1 are mixed. Accordingly, it is difficult for an observer to recognize a decrease in resolution of the display image in each unit period U.

In the embodiment, the signal line driving circuit 44 commonly supplies the grayscale potential X corresponding to the grayscale calculated as an average of the grayscales designated to four pixels PIX by the display data V, to the four pixels PIX belonging to the block BL designated in each unit period U (U1 and U2). Accordingly, for example, it is possible to decrease a changed amount of the grayscale of each pixel PIX between the unit period U1 and the unit period U2, compared to a case of commonly supplying the grayscale potential X corresponding to the grayscale designated to the reference pixel of each block BL by the display data V to the four pixels PIX configuring the block BL.

That is, in the first embodiment, since the changed amount of the grayscale (first set grayscale) designated in each pixel PIX in the unit period U1 and the grayscale (second set grayscale) designated in each pixel PIX in the unit period U2 are suppressed to be small, it is possible to decrease a possibility of the change in the grayscale of each pixel PIX to be recognized by an observer as flickering.

### B. SECOND EMBODIMENT

In the first embodiment, the block BL[2p−1][2q−1] selected in the unit period U1 and the block BL[2q][2q] selected in the unit period U2 are in a relationship shifted in the vertical and horizontal directions (x direction and y direction) by one pixel.

With respect to this, in the second embodiment, the block BL selected in the unit period U1 and the block BL selected in the unit period U2 are in a relationship shifted in the vertical direction (y direction) by one pixel, and this is a point different from the first embodiment.

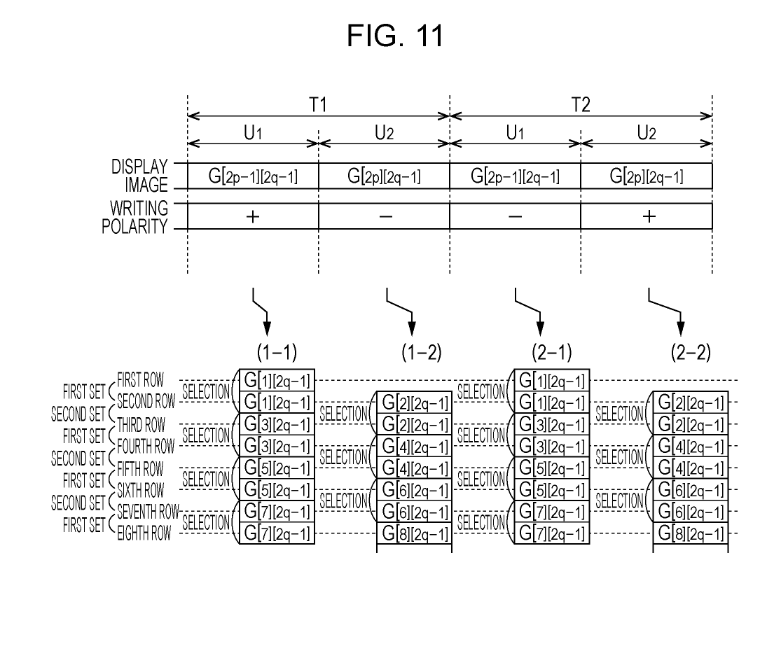

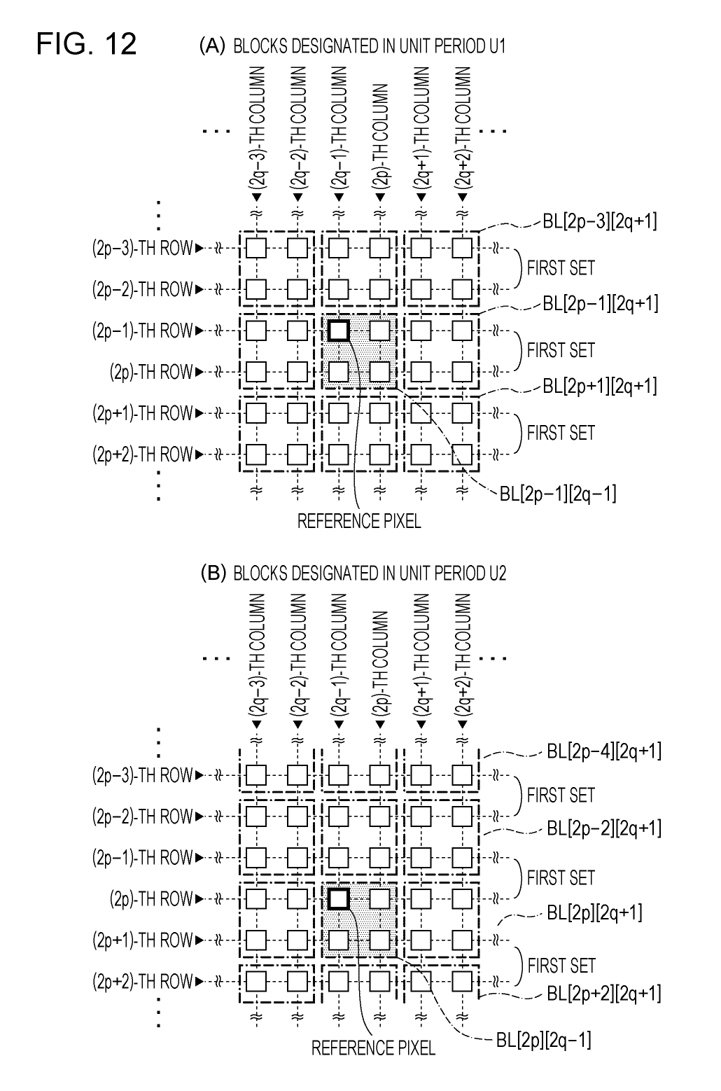

Hereinafter, with reference to FIG. 11 and FIG. 12, the display device 10 according to the second embodiment will be described. For the elements with the same operation or the function in each embodiment shown below as in the first embodiment, the reference numerals referred in the above description are used and each specific description will be appropriately omitted.

As shown in a part (1-1) and a part (2-1) of FIG. 11, in the first selection period H in the unit period U1, the grayscale potential X corresponding to the grayscale G[1][2q−1] is commonly supplied to the four pixels PIX belonging to the block BL[1][2q−1]. In the second selection period H in the unit period U1, the grayscale potential X corresponding to the grayscale G[3][2q−1] is commonly supplied to the four pixels PIX belonging to the block BL[3][2q−1].

That is, as shown in FIG. 12(A), the signal line driving circuit 44 according to the second embodiment commonly supplies the grayscale potential X[2q−1] corresponding to the grayscale G[2p−1][2q−1] to the two signal lines 34 (signal lines 34 of the first set) in the (2q−1)-th column and the (2q)-th column, in the unit period U1. That is, in the unit period U1, the grayscale potential X[2q−1] corresponding to the grayscale G[2p−1][2q−1] is commonly supplied to the four pixels PIX configuring the block BL[2p−1][2q−1].

Meanwhile, as shown in a part (1-2) and a part (2-2) of FIG. 11, in the first selection period H in the unit period U2, the grayscale potential X corresponding to the grayscale G[2][2q−1] is commonly supplied to the four pixels PIX belonging to the block BL[2][2q−1]. In the second selection period H in the unit period U2, the grayscale potential X corresponding to the grayscale G[4][2q−1] is commonly supplied to the four pixels PIX belonging to the block BL[4][2q−1].

That is, as shown in FIG. 12(B), the signal line driving circuit 44 according to the second embodiment commonly supplies the grayscale potential X[2q−1] corresponding to the grayscale G[2p][2q−1] to the two signal lines 34 (signal lines 34 of the first set) in the (2q−1)-th column and the (2q)-th column, in the unit period U2. That is, in the unit period U2, the grayscale potential X[2q−1] corresponding to the grayscale G[2p][2q−1] is commonly supplied to the four pixels PIX configuring the block BL[2p][2q−1].

Even in the second embodiment, the image displayed in the unit period U1 immediately before the unit period U2 and the image displayed in the unit period U2 are mixed in the unit period U2. In the same manner as described above, the image displayed in the unit period U2 immediately before the unit period U1 and the image displayed in the unit period U1 are mixed in the unit period U1. Accordingly, it is advantageous that an observer hardly recognizes a decrease in resolution of the display image in each unit period U.

In addition, even in the second embodiment, in each selection period H, the common grayscale potential X[n] is simultaneously supplied to the two signal lines 34 adjacent to each other. Accordingly, it is possible to suppress the operation speed of the control circuit 14 and the driving circuit 40 approximately to a half value of the comparative example. That is, the display device 10 according to the second embodiment has an advantage of decreasing circuit scale and manufacturing cost of the driving circuit.

### C. MODIFICATION EXAMPLE

Each embodiment described above can obtain various modification examples. The specific modification embodiments will be described later. The two or more embodiments arbitrarily selected from the following examples can be suitably combined within a range not inconsistent with each other.

### Modification Example 1

The display device 10 according to the first embodiment described above sets each of the plurality of pixels PIX positioned in the odd row and the odd column as reference pixel in the unit period U1 and designates the plurality of blocks BL corresponding to each of the plurality of reference pixels, and sets each of the plurality of pixels PIX positioned in the even row and the even column as reference pixel in the unit period U2 and designates the plurality of blocks BL corresponding to each of the plurality of reference pixels, but the present invention is not limited to such embodiment. The display device 10 may set each of the plurality of pixels PIX positioned in the even row and the even column as reference pixel in the unit period U1 and designate the plurality of blocks BL corresponding to each of the plurality of reference pixels, and may set each of the plurality of pixels PIX positioned in the odd row and the odd column as reference pixel in the unit period U2 and designate the plurality of blocks BL corresponding to each of the plurality of reference pixels.

### Modification Example 2

In the first embodiment and the modification example described above, the block BL designated by the display device 10 in the unit period U2 is shifted to the block BL designated in the unit period U1 in the x direction and the y direction by one pixel, and in the second embodiment described above, the block BL designated by the display device 10 in the unit period U2 is shifted to the block BL designated in the unit period U1 in the y direction by one pixel, but the present invention is not limited to such embodiment. The block may be shifted in at least one of the x direction and the y direction by one pixel. For example, the block designated in the unit period U2 may be shifted to the block BL designated in the unit period U1 in the x direction by one pixel.

### Modification Example 3

The display device 10 according to the embodiments and the modification examples described above determines the grayscale X[n] supplied to each pixel PIX according to the grayscale calculated as a result of the calculation shown in the equation (1) to equation (4), but the present invention is not limited to such embodiment. The display device may perform the calculation shown in the equation (1) to equation (4) only in a case where the predetermined conditions are satisfied. For example, among the grayscales designated by the display data V in the four pixels PIX belonging to a certain block BL, only in a case where a difference between the maximum grayscale and the minimum grayscale is larger than a predetermined threshold value, the calculation shown in the equation (1) to equation (4) may be performed.

More specifically, among the grayscales designated by the display data V in the four pixels PIX belonging to a certain block BL[m][n], the maximum value is set as a maximum display grayscale Vmax[m][n], the minimum value is set as a minimum display grayscale Vmin[m][n], and an absolute value of a difference between the maximum display grayscale Vmax[m][n] and the minimum display grayscale Vmin[m][n] is set as a difference grayscale ΔV[m][n]. When the difference grayscale ΔV[m][n] is larger than a predetermined threshold value α, the control circuit 14 and the driving circuit 40 commonly supplies the grayscale potential X corresponding to the grayscale calculated as an average of the grayscales designated by the display data V in each of the four pixels PIX belonging to the block BL[m][n], to each of the four pixels PIX belonging to the block BL[m][n]. Meanwhile, when the difference grayscale ΔV[m][n] is equal to or smaller than the predetermined threshold value α, the control circuit and the driving circuit commonly supplies the grayscale potential X corresponding to the grayscale designated by the display data V in the four pixels PIX in the predetermined position (for example, pixel PIX in the m-th row and the n-th column which is the reference pixel of the block BL[m][n]) among the four pixels PIX belonging to the block BL[m][n].

As described above, when the difference between the maximum grayscale and the minimum grayscale is larger than a predetermined threshold value, among the grayscales designated by the display data V in the four pixels PIX belonging to a certain block BL, the display device 10 according to the modification example calculates the average of the grayscales designated by the display data V in each of the four pixels PIX belonging to the block BL by the calculation shown in the equation (1) to equation (4) and commonly supplies the grayscale potential X corresponding to the calculated value to the four pixels PIX. Accordingly, when the calculation shown in the equation (1) to equation (4) is not performed, for example, it is possible to decrease a difference between the grayscale (first set grayscale) designated in each pixel PIX in the unit period U1 and the grayscale (second set grayscale) designated in each pixel PIX in the unit period U2, compared to a case of constantly commonly supplying the grayscale potential X corresponding to the grayscale designated by the display data V in the pixel PIX in the predetermined position among the four pixels PIX belonging to the certain block BL, to the four pixels PIX belonging to the block BL. Accordingly, it is possible to decrease a possibility that an observer recognizes “flickering”.

### Modification Example 4

In the embodiments and the modification example described above, the four weighting coefficients w used in calculation of the weighted average for calculating the image signal G from the display data V are set to be equivalent value, but the present invention is not limited to such embodiment. The four weighting coefficients w may be set to different values from each other.

When the four weighting coefficients w used in calculation of the weighted average for calculating the image signal G from the display data V are set to be equivalent value, the display device 10 may display an image having lower contrast, compared to an original image shown by the display data V. For example, as shown in FIG. 6(A), when the image shown by the display data V is an image displaying a white background and a black figure and the four weighting coefficients w are set to be equivalent value, the image displayed by the display device 10 may display the figure to be originally displayed in black, with a gray color.

The display device 10 according to this modification example determines the four weighting coefficients w used in calculation of the weighted average for calculating the grayscale of the four pixels PIX belonging to the block BL, based on a relationship between the grayscale designated by the display data V in each of the four pixels PIX and the grayscale designated by the display data V in each of the predetermined number of pixels PIX including the four pixels PIX. That is, the display device 10 according to this modification example controls the grayscale of each block BL based on a relationship between the grayscale of the four pixels PIX belonging to each block BL and the grayscale of the plurality of pixels PIX present in the surrounding of each block BL. Accordingly, the display device 10 according to this modification example can display an image which is clear as the display image which is shown by the display data and is to be originally displayed.

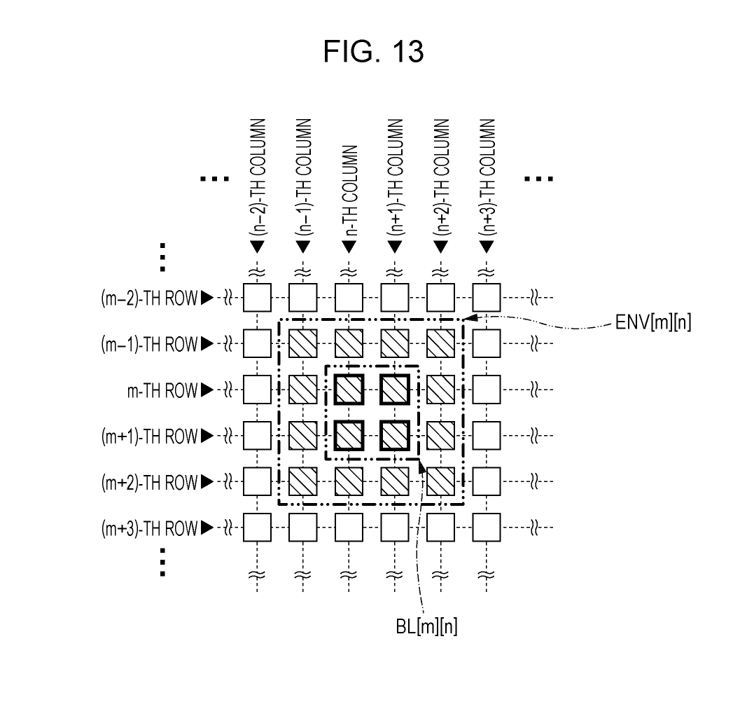

With reference to FIG. 13, an example of a specific determination method of the four weighting coefficients w will be described.

First, the control circuit 14 calculates an average value of the grayscales designated by the display data V in each of the predetermined number of pixels ENV[m][n] including the four pixels PIX belonging to the certain block BL[m][n] as an average grayscale VAVE[m][n]. The predetermined number of pixels ENV[m][n] including the four pixels PIX belonging to the block BL[m][n] may be suitably determined so as to include the block BL[m][n]. In this modification example, as shown in FIG. 13, total 16 pixels PIX configured with the four pixels belonging to the block BL[m][n] and 12 pixels PIX surrounding the four pixels PIX are set as the predetermined number of pixels ENV[m][n].

Next, among the grayscales designated by the display data V in the four pixels PIX belonging to a certain block BL[m][n], when maximum value is set as a maximum display grayscale Vmax[m][n] and the minimum value is set as a minimum display grayscale Vmin[m][n], the control circuit 14 calculates an absolute value of a difference between the maximum display grayscale Vmax[m][n] and the average grayscale VAVE[m][n] as a first difference grayscale ΔV1[m][n], and calculates an absolute value of a difference between the average grayscale VAVE[m][n] and the minimum display grayscale Vmin[m][n] as a second difference grayscale ΔV2[m][n].

When the first difference grayscale ΔV1[m][n] is a value larger than the second difference grayscale ΔV2[m][n], the control circuit 14 sets the weighting coefficient w corresponding to the four pixels PIX in which the maximum display grayscale Vmax[m][n] is designated by the display data V, as a value larger than the three weighting coefficients w corresponding to the other three pixels PIX. For example, the weighting coefficient w corresponding to the pixel PIX in which the maximum display grayscale Vmax[m][n] is designated by the display data V, is set as “2” and the three weighting coefficients w corresponding to the other three pixels PIX are set as “1”.

In contrast, when the second difference grayscale ΔV2[m][n] is a value larger than the first difference grayscale ΔV1[m][n], the control circuit 14 sets the weighting coefficient w corresponding to the pixel PIX in which the minimum display grayscale Vmin[m][n] is designated by the display data V, as a value larger than the three weighting coefficients w corresponding to the other three pixels PIX, among the four pixels PIX. For example, the weighting coefficient w corresponding to the pixel PIX in which the minimum display grayscale Vmin[m][n] is designated by the display data V, is set as “2” and the three weighting coefficients w corresponding to the other three pixels PIX are set as “1”.

As described above, according to this modification example, when the grayscale designated in the four pixels PIX belonging to the block BL[m][n] by the display data V and the grayscale designated in each of the plurality of pixels present in the surrounding of the block BL[m][n] are largely different from each other, the four weighting coefficients w are determined so that the grayscale displayed by the block BL[m][n] and the grayscales displayed by the plurality of pixels PIX present in the surrounding of the block BL[m][n] are largely different from each other. Accordingly, the certain pixel PIX can display the grayscale close to the grayscale designated by the display data V.

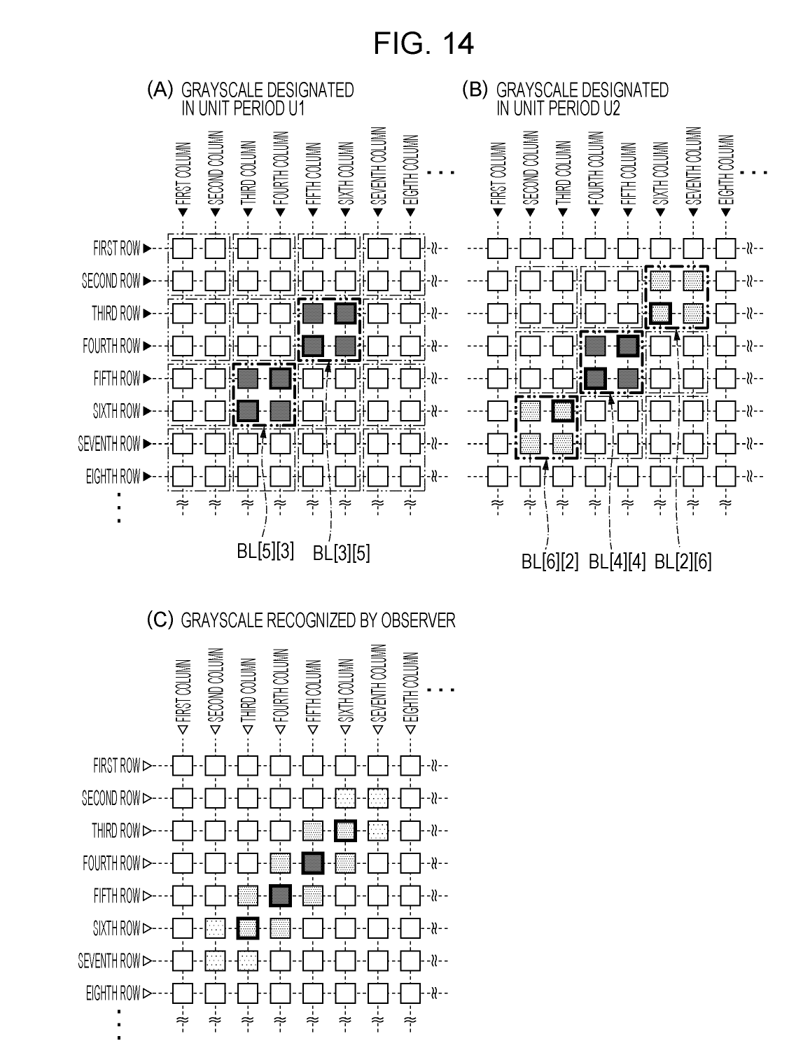

For example, according to the display device 10 according to this modification example, as shown in FIG. 14(A), when the grayscale shown by the display data V shown in FIG. 6(A) is supplied from an external circuit, a grayscale difference between the grayscale displayed by the four pixels PIX belonging to the block BL[5][3] in the unit period U1 and the grayscale displayed by the pixel PIX in the surrounding of the four pixels PIX becomes large, compared to a case of the first embodiment shown in FIG. 6(B). The same applies to the four pixels PIX belonging to the block BL[3][5]. As shown in FIG. 14(B), a gradation difference between the grayscale displayed by the four pixels PIX belonging to the block BL[4][4] in the unit period U2 and the grayscale displayed by the pixel PIX in the surrounding of the four pixels PIX becomes large, compared to a case of the first embodiment shown in FIG. 6(C). The same applies to the pixels PIX belonging to the block BL[6][2] and block BL[2][6]. Accordingly, as shown in FIG. 14(C), an observer recognizes the grayscale close to the grayscale (FIG. 6(A)) showing the original image and shown by the display data V, compared to a case of the first embodiment (FIG. 7), as the grayscale displaying each pixel PIX.

### Modification Example 5

In the embodiments and the modification example described above, the average value of the grayscales designated by the display data V in each of the four pixels PIX belonging to the block BL is calculated, and the grayscale potential X corresponding to the grayscale calculated as the average value is supplied to the four pixels PIX, but the present invention is not limited to such embodiment. The grayscale potential X corresponding to the grayscale obtained by multiplying the coefficient (grayscale control coefficient ρ) by the average value may be commonly supplied to each of the four pixels PIX. That is, the grayscale designated to the four pixels PIX by the image signal G may be set to a value obtained by multiplying the grayscale control coefficient ρ by the average value.

At that time, the grayscale control coefficient ρ corresponding to the certain block BL may be determined based on a relationship between the grayscales designated by the display data V in each of the four pixels PIX belonging to the block BL and the grayscales designated by the display data V to the predetermined number of pixels PIX configured with the plurality of pixels PIX present in the surrounding of the four pixels PIX. Accordingly, the display device 10 according to this modification example controls the grayscale of each block BL based on the relationship between the grayscale of four pixels PIX belonging to each block BL and the grayscale of the plurality of pixels PIX present in the surrounding of each block BL. That is, the display device 10 according to this modification example can display an image which is clear as the display image which is shown by the display data and is to be originally displayed.

Hereinafter, an example of a determination method of the grayscale control coefficient ρ and a calculation method of the grayscale designated in the block BL by the image signal G will be specifically described. Hereinafter, the grayscale control coefficient ρ for determining the grayscale of the four pixels PIX belonging to the block BL[m][n] is represented as the grayscale control coefficient ρ[m][n].

First, the control circuit 14 calculates an average value of the grayscales designated by the display data V in each of the four pixels PIX belonging to the certain block BL[m][n] as the average grayscale BAVE[m][n] (first average grayscale).

In addition, the control circuit 14 calculates an average value of the grayscales designated by the display data V in each of the predetermined number of pixels ENV[m][n] including the four pixels PIX belonging to the certain block BL[m][n] as the average grayscale VAVE[m][n] (second average grayscale). The predetermined number of pixels ENV[m][n] including the four pixels PIX belonging to the block BL[m][n] may be suitably determined so as to include the block BL[m][n]. In this modification example, in the same manner as in the modification example 4, total 16 pixels PIX configured with the four pixels belonging to the block BL[m][n] and 12 pixels PIX surrounding the four pixels PIX are set as the predetermined number of pixels ENV[m][n] (see FIG. 13).

Next, among the grayscales designated by the display data V in the four pixels PIX belonging to a certain block BL[m][n], when maximum value is set as a maximum display grayscale Vmax[m][n] and the minimum value is set as a minimum display grayscale Vmin[m][n], the control circuit 14 calculates an absolute value of a difference between the maximum display grayscale Vmax[m][n] and the average grayscale VAVE[m][n] as a first difference grayscale ΔV1[m][n], and calculates an absolute value of a difference between the average grayscale VAVE[m][n] and the minimum display grayscale Vmin[m][n] as a second difference grayscale ΔV2[m][n].

When the first difference grayscale ΔV1[m][n] is a value larger than the second difference grayscale ΔV2[m][n], the control circuit 14 sets the grayscale control coefficient ρ[m][n] to a value larger than “1”. In contrast, when the second difference grayscale ΔV2[m][n] is a value larger than the first difference grayscale ΔV1[m][n], the control circuit 14 sets the grayscale control coefficient ρ[m][n] to a value larger than “0” and smaller than “1”.

The control circuit 14 sets the grayscale G[m][n] designated to the four pixels PIX belonging to the block BL[m][n] by the image signal G, to the grayscale obtained by multiplying the grayscale control coefficient ρ[m][n] by the average grayscale BAVE[m][n]. That is, the grayscale potential X corresponding to the grayscale obtained by multiplying the grayscale control coefficient ρ[m][n] by the average grayscale BAVE[m][n] is commonly supplied to the four pixels PIX belonging to the block BL[m][n].

As described above, the display device 10 according to the modification example determines the grayscales of the four pixels PIX belonging to the block BL based on the grayscale designated by the display data V in each of the four pixels PIX and the grayscales designated by the display data V in the predetermined number of pixels PIX including the four pixels PIX. Accordingly, the display device 10 according to this modification example can display an image which is clear as the display image which is shown by the display data and is to be originally displayed.

### Modification Example 6

In the embodiment and the modification example described above, the pixel PIX includes the liquid crystal element CL as an electrooptical element, but an electrophoretic element may be used as an electrooptical element. That is, the electrooptical element includes a display element in which optical properties (for example, transmittance) changes depending on electrical action (for example, application of voltage).

### Modification Example 7

In the embodiment and the modification example described above, an example in which the scanning line 32 of the first set and the scanning line 32 of the second set selected by the scanning line driving circuit 42 are in a relationship shifted in the y direction by one scanning line 32, using the pixels PIX belonging to the block BL as a unit of four pixels of two vertical rows and two horizontal columns, has been described, but the scanning line 32 of the first set and the scanning line 32 of the second set selected by the scanning line driving circuit 42 can be in a relationship shifted in the y direction by one or two scanning lines 32, using the pixels PIX belonging to the block BL as a unit of nine pixels of three vertical rows and three horizontal columns. In addition, the first set and the second set selected by the scanning line driving circuit 42 can be in a relationship shifted in the y direction by any one of one to three scanning lines 32, using the pixels PIX belonging to the block BL as a unit of 16 pixels of four vertical rows and four horizontal columns. In addition, the pixels PIX belonging to the block BL can be a unit of six pixels of two vertical rows and three horizontal columns or 12 pixels of three vertical rows and four horizontal columns.

### Modification Example 8

In the embodiments and the modification example described above, each of the selection circuits SEL1 to SELk is connected to five signal lines 34, but the present invention is not limited thereto, and each of the selection circuits may be connected to J (J is a natural number equal to or larger than 3) signal lines 34.

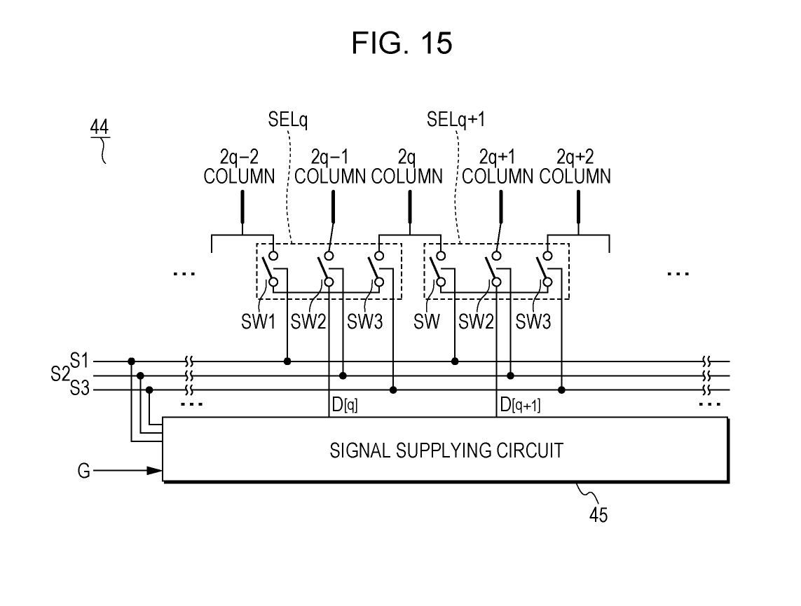

FIG. 15 shows a configuration of the signal line driving circuit 44 according to the modification example.

In the signal line driving circuit 44 according to the modification example, the selection circuits SEL are provided to correspond to the signal line 34 in the odd column ((2q−1)-th column). Among these, the selection circuit SEL on the left end includes one input terminal, two output terminals, and two switches. The selection circuit SEL on the right end includes one input terminal, one output terminal, one switch, when the number N of the signal lines 34 is even, and includes one input terminal, two output terminals, and two switches, when N is odd. In addition, each selection circuit SEL except for those on both ends includes one input terminal, three output terminals, and three switches. Each output terminal included by the selection circuit SEL is connected to each signal line 34.

Each selection circuit SEL except for those on both ends includes the switches SW1 to SW3. The switches SW1 to SW3 are controlled to be turned on and off by the control signal S1 to S3. Specifically, when the control signal S1 is in an active state (high level), the switch SW1 is turned on, when the control signal S2 is in an active state, the switch SW2 is turned on, and when the control signal S3 is in an active state, the switch SW3 is turned on.

The signal supply circuit 45 generates data signal D[q] based on the image signal G and the control signals S1 to S3. This data signal D[q] is obtained by time division multiplex of the grayscale potential supplied to pixels of two columns. The selection circuit SELq has a function of distributing the grayscale potential obtained by decoding the data signal D[q] subjected to the time division multiplex, to the pixels of two columns.

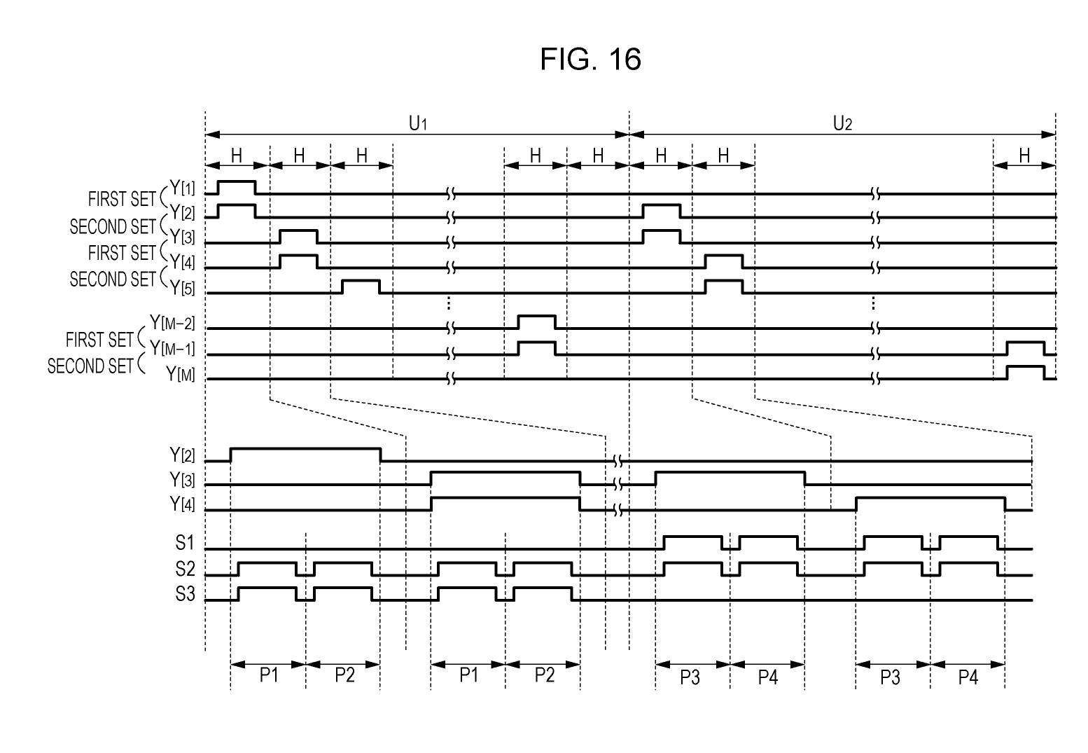

FIG. 16 is a timing chart of the signal line driving circuit 44 according to this modification example.

First, in the unit period U1, the scanning signal Y[2p−1] and the scanning signal Y[2p] are simultaneously turned into an active state and the scanning lines 32 of the first set are simultaneously selected.

In the unit period U1, the period P1 and the period P2 are set in the period in which the scanning lines 32 of the first set are simultaneously selected. Among these, the period P1 is a period in which the precharge potential Vpre is supplied to the signal line 34. The period P2 is a period in which the grayscale potential is supplied to pixels belonging to the block.

In the period P1, the control signals S2 and S3 are turned into an active state and the control signal S1 is turned into an inactive state. Accordingly, the precharge potential Vpre is written in the pixel PIX through the switches SW2 and SW3.

Next, in the period P2, the control signals S2 and S3 are turned into an active state and the control signal S1 is turned into an inactive state. Accordingly, for example, regarding the selection circuit SELq, the grayscale potential X[2q−1] corresponding to the grayscales G[2p−1][2q−1] is written to each pixel PIX belonging to the block BL[2p−1][2q−1] in the (2q−1)-th column and the (2q)-th column through the switches SW2 and SW3, and regarding the selection circuit SELq+1, grayscale potential X[2q+1] corresponding to the grayscales G[2p−1][2q+1] is written to each pixel PIX belonging to the block BL[2p−1][2q+1] in the (2q+1)-th column and the (2q+2)-th column through the switches SW2 and SW3.

That is, in the period P2 of the unit period U1, the control circuit 14 turns on the switch SW2 and the switch SW3 and turns off the switch SW1. Accordingly, in the period P2 of the unit period U1, the common grayscale potential X[2q−1] is supplied to the pixel PIX of the block BL[2p−1][2q−1] provided corresponding to the signal line 34 of the first set to which the switch SW2 and the switch SW3 are connected.

Meanwhile, in the unit period U2, the scanning signal Y[2p] and the scanning signal Y[2p+1] are simultaneously turned into an active state and the scanning lines 32 of the second set are simultaneously selected.

In the unit period U2, the period P3 and the period P4 are set in the period in which the scanning lines 32 of the second set are simultaneously selected. Among these, the period P3 is a period in which the precharge potential Vpre is supplied to the signal line 34. The period P4 is a period in which the grayscale potential is supplied to pixels belonging to the block.

In the period P3, the control signals S1 and S2 are turned into an active state and the control signal S3 is turned into an inactive state. Accordingly, the precharge potential Vpre is written in the pixel PIX through the switches SW1 and SW2.

Next, in the period P4, the control signals S1 and S2 are turned into an active state and the control signal S3 is turned into an inactive state. Accordingly, for example, regarding the selection circuit SELq, the grayscale potential X[2q−2] corresponding to the grayscales G[2p][2q−2] is written to each pixel PIX belonging to the block BL[2p][2q−2] in the (2q−2)-th column and the (2q−1)-th column through the switches SW1 and SW2, and regarding the selection circuit SELq+1, grayscale potential X[2q] corresponding to the grayscales G[2q][2q] is written to each pixel PIX belonging to the block BL[2q][2q] in the (2q)-th column and the (2q+1)-th column through the switches SW1 and SW2.

That is, in the period P4 of the unit period U2, the control circuit 14 turns on the switch SW1 and the switch SW2 and turns off the switch SW3. Accordingly, in the period P4 of the unit period U2, the common grayscale potential X[2q] is supplied to the pixel PIX of the block BL[2q][2q] provided corresponding to the signal line 34 of the second set to which the switch SW1 and the switch SW2 are connected.

In this modification example, the switch SW3 of the selection circuit SELq is referred to as a “first switch”, the switch SW2 of the selection circuit SELq is referred to as a “second switch”, the switch SW1 of the selection circuit SELq+1 is referred to as a “third switch”, and the switch SW2 of the selection circuit SELq+1 is referred to as a “fourth switch”.

### Modification Example 9

In the embodiments and the modification example described above, the signal line driving circuit 44 is provided in the electrooptical panel 12, but the present invention is not limited thereto, and a part or the entire thereof may be provided at the outside of the electrooptical panel 12 (liquid crystal panel). More specifically, the selection circuit SEL may be provided in the display device 10 and the signal supply circuit 45 may be provided at the outside. In this case, it is possible to decrease the number of connection terminals, compared to a case where the signal line driving circuit 44 is provided at the outside. As a result, it is possible to widen a gap between the connection terminals, even when a pixel pitch is narrowed, and accordingly, it is possible to prevent short circuit between the connection terminals and to improve reliability of the display device 10.

In addition, in the embodiment and the modification example described above, the precharge potential Vpre is supplied before supplying the grayscale potential to the signal line 34, but the present invention is not limited thereto. The precharge potential Vpre may not be supplied.

### D. APPLICATION EXAMPLE

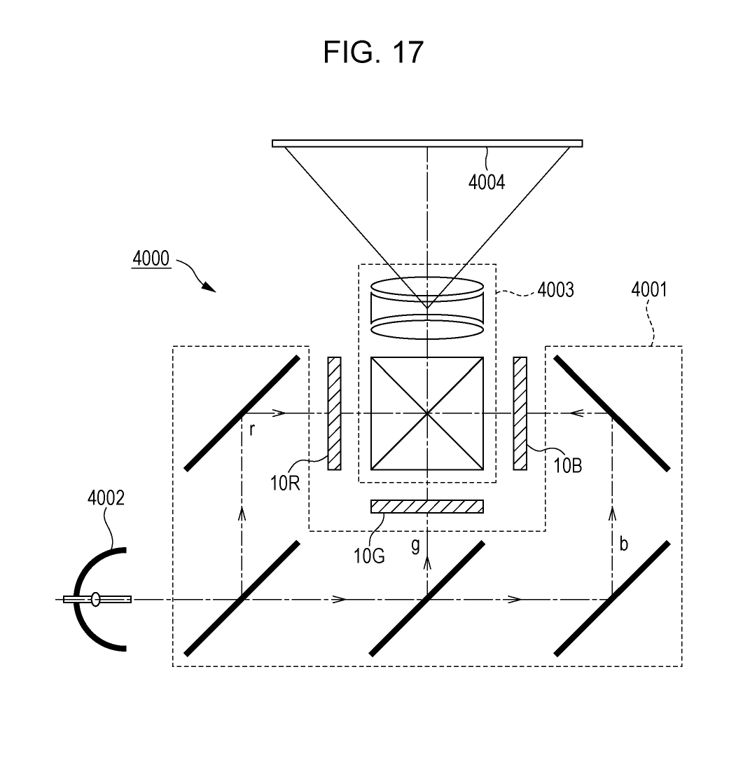

The display device 10 exemplified in each embodiment described above can be used in various electronic apparatuses. FIG. 17 to FIG. 19 show specific embodiments of electronic apparatuses using the display device 10.

FIG. 17 is a schematic diagram of a projection type display device (3 plate-type projector) 4000 using the display device 10. The projection type display device 4000 is configured to include three display devices 10 (10R, 10G, and 10B) corresponding to display colors (red, green, and blue) different from each other. An illumination optical system 4001 supplies a red component r to the display device 10R, supplies a green component g to the display device 10G, and supplies a blue component b to the display device 10B among light beams emitted from an illumination apparatus (light source) 4002. Each display device 10 functions as an optical modulator (light valve) which modulates each monochromatic light beam supplied from the illumination optical system 4001 according to the display image. A projection optical system 4003 synthesizes the light beams emitted from each display device 10 and projects the light on a projection surface 4004. An observer observes an image projected on the projection surface 4004.

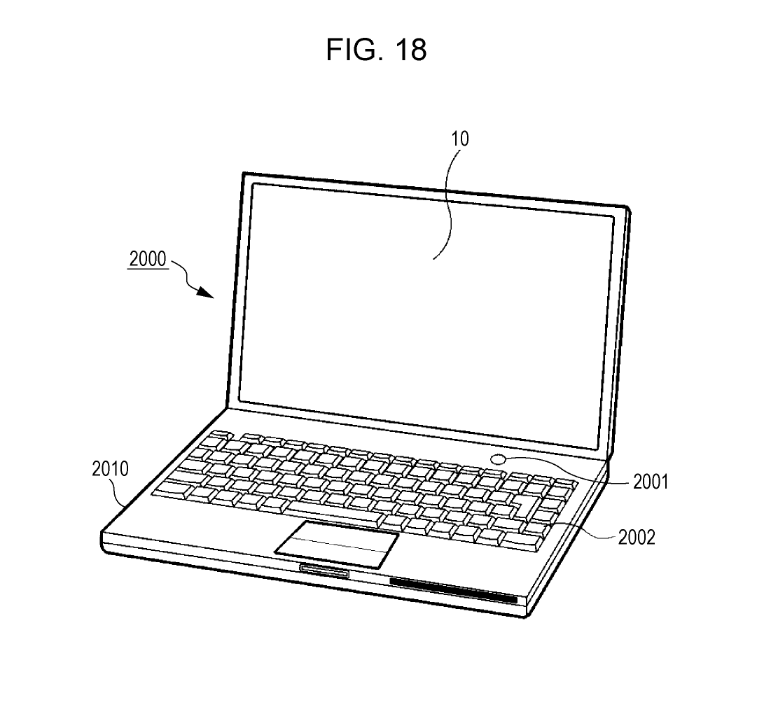

FIG. 18 is a perspective view of a portable personal computer using the display device 10. A personal computer 2000 includes the display device 10 which displays various images and a main body unit 2010 in which a power switch 2001 and a keyboard 2002 are installed.

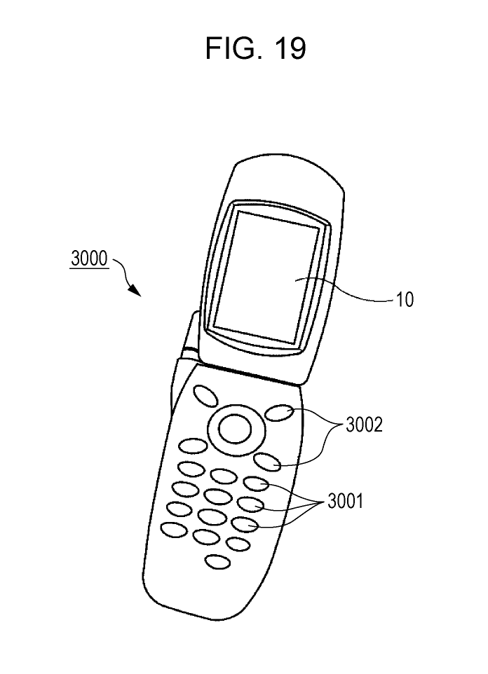

FIG. 19 is a perspective view of a mobile phone using the display device 10. A mobile phone 3000 includes various operation buttons 3001, scroll buttons 3002, and the display device 10 which displays various images. A screen displayed on the display device 10 is scrolled by operating the scroll buttons 3002.

In addition to the apparatuses shown in FIG. 17 to FIG. 19, as the electronic apparatus using the electrooptical apparatus according to the present invention, a personal digital assistants (PDA), a digital still camera, a television, a video camera, a car navigation apparatus, a display for car (instrument panel), an electronic organizer, an electronic paper, a calculator, a word processor, a work station, a video phone, a POS terminal, a printer, a scanner, a copier, a video player, or an apparatus including a touch panel are used.

This application claims priority to Japan Patent Application No. 2012-287711 filed Dec. 28, 2012, the entire disclosures of which are hereby incorporated by reference in their entireties.

### REFERENCE SIGNS LIST

10 DISPLAY DEVICE

12 ELECTROOPTICAL PANEL

14 CONTROL CIRCUIT

30 PIXEL UNIT

PIX PIXEL

CL LIQUID CRYSTAL ELEMENT

32 SCANNING LINE

34 SIGNAL LINE

40 DRIVING CIRCUIT

42 SCANNING LINE DRIVING CIRCUIT

44 SIGNAL LINE DRIVING CIRCUIT

45 SIGNAL SUPPLY CIRCUIT

SEL SELECTION CIRCUIT

1. A display device comprising:
a first scanning line;
two second scanning lines which are adjacent to the first scanning line and interpose the first scanning line;
a first signal line and a second signal line which intersect with the first scanning line and the second scanning line and are adjacent to each other;
a plurality of pixels which are provided to correspond to the intersection of the first scanning line and the second scanning line, and the first signal line and the second signal line;
a first driving circuit which selects scanning lines of a first set configured with the first scanning lines and one second scanning line among the two second scanning lines in a first unit period, and selects scanning lines of a second set configured with the first scanning line and the other second scanning line among the two second scanning lines in a second unit period after the first unit period has elapsed; and
a second driving circuit which supplies a first grayscale potential to a first pixel block which is four pixels corresponding to an intersection of the scanning lines of the first set, the first signal line, and the second signal line selected by the first driving circuit in the first unit period, and supplies a second grayscale potential to a second pixel block which is four pixels corresponding to an intersection of the scanning lines of the second set, the first signal line, and the second signal line selected by the first driving circuit in the second unit period.

2. A display device comprising:
a first scanning line;
two second scanning lines which are adjacent to the first scanning line and interpose the first scanning line;
a first signal line which intersects with the first scanning line and the second scanning line;
two second signal lines which intersect with the first scanning line and the second scanning line, are adjacent to the first signal line, and interpose the first signal line;
a plurality of pixels which are provided to correspond to the intersection of the first scanning line and the second scanning line, and the first signal line and the second signal line;
a first driving circuit which selects scanning lines of a first set configured with the first scanning lines and one second scanning line among the two second scanning lines in a first unit period, and selects scanning lines of a second set configured with the first scanning line and the other second scanning line among the two second scanning lines in a second unit period after the first unit period has elapsed; and
a second driving circuit which supplies a first grayscale potential to a first pixel block which is four pixels corresponding to an intersection of the scanning lines of the first set selected by the first driving circuit and signal lines of the first set configured with the one second signal line among the two second signal lines and the first signal line in the first unit period, and supplies a second grayscale potential to a second pixel block which is four pixels corresponding to an intersection of the scanning lines of the second set selected by the first driving circuit and signal lines of the second set configured with the other second signal line among the two second signal lines and the first signal line in the second unit period.

3. The display device according to claim 2, wherein:
the display device further includes a control circuit which controls the second driving circuit;
the second driving circuit includes:
a signal supply circuit which outputs the first grayscale potential or the second grayscale potential;
a first switch of which one end is electrically connected to the signal supply circuit and the other end is electrically connected to the first signal line;
a second switch of which one end is electrically connected to the signal supply circuit and the other end is electrically connected to the one second signal line;
a third switch of which one end is electrically connected to the signal supply circuit and the other end is electrically connected to the first signal line; and
a fourth switch of which one end is electrically connected to the signal supply circuit and the other end is electrically connected to the other second signal line;
the control circuit turns on the first switch and the second switch and turns off the third switch, the signal supply circuit outputs the first grayscale potential to one end of the first switch and one end of the second switch, in the first unit period; and
the control circuit turns on the third switch and the fourth switch and turns off the first switch, and the signal supply circuit outputs the second grayscale potential to one end of the third switch and the one end of the fourth switch, in the second unit period.

4. The display device according to claim 3, wherein:
display data showing the grayscale to be displayed by the pixel is supplied to the control circuit;
the control circuit calculates a weighted average of the grayscale designated by the display data as the grayscale to be displayed in each of four pixels belonging to the first pixel block, supplies a first image signal showing the calculated grayscale to the signal supply circuit, calculates a weighted average of the grayscale designated by the display data as the grayscale to be displayed in each of four pixels belonging to the second pixel block, and supplies a second image signal showing the calculated grayscale to the signal supply circuit; and
the signal supply circuit which outputs the first grayscale potential when the first image signal is supplied, and outputs the second grayscale potential when the second image signal is supplied.

5. The display device according to claim 4, wherein:
the control circuit sets weighting coefficients to be applied to the grayscale of each pixel in the calculation of the weighted average to a value larger than 0.

6. The display device according to claim 4, wherein:
the control circuit sets weighting coefficients to be applied to the grayscale of each pixel in the calculation of the weighted average to an equivalent value.

7. The display device according to claim 2, wherein:
the display device displays a series of planar images.

8. (canceled)

9. The display device according to claim 5, wherein:
the control circuit sets weighting coefficients to be applied to the grayscale of each pixel in the calculation of the weighted average to an equivalent value.

10. The display device according to claim 4, wherein:
The display device displays a series of planar images.

11. The display device according to claim 1, wherein:
The display device displays a series of planar images.

12. An electronic apparatus comprising the display device according to claim 1.

13. An electronic apparatus comprising the display device according to claim 2.

14. An electronic apparatus comprising the display device according to claim 3.

15. An electronic apparatus comprising the display device according to claim 4.

16. An electronic apparatus comprising the display device according to claim 5.

17. An electronic apparatus comprising the display device according to claim 6.

18. An electronic apparatus comprising the display device according to claim 7.

19. An electronic apparatus comprising the display device according to claim 9.

20. An electronic apparatus comprising the display device according to claim 10.

21. An electronic apparatus comprising the display device according to claim 10.
